(19) United States
(12) Patent Application Publication
(10) Pub. No.: US 2025/0216365 A1
(43) Pub. Date: Jul. 3, 2025

(54) METHODS OF MASS SPECTROMETRY, A MASS SPECTROMETER AND COMPUTER SOFTWARE

(71) Applicant: Thermo Fisher Scientific (Bremen) GmbH, Bremen (DE)

(72) Inventors: Hamish Stewart, Bremen (DE); Alexander A. Makarov, Bremen (DE)

(73) Assignee: Thermo Fisher Scientific (Bremen) GmbH, Bremen (DE)

(21) Appl. No.: 19/007,299

(22) Filed: Dec. 31, 2024

(30) Foreign Application Priority Data
Jan. 3, 2024 (GB) 2400067.1

(51) Int. Cl. G01N 30/72; G01N 30/02; G01N 30/84; H01J 49/00

(52) U.S. Cl. CPC G01N 30/7266; G01N 30/84; H01J 49/004; G01N 2030/027; G01N 2030/8417

(57) ABSTRACT

Methods of mass spectrometry comprise, for each of a plurality of sub-ranges in an overall m/z range, configuring an ion beam switch to direct ions towards a first ion store; accumulating in the first ion store a sample of precursor ions to be analysed, the precursor ions having m/z values within the sub-range. The ion beam can be configured to direct ions towards a first mass analyser and inject a sample of fragmented precursor ions into the first mass analyser, wherein the sample of fragmented precursor ions is formed from fragmentation of precursor ions having m/z values within the sub-range. Alternatively, the ion beam directs ions towards a second ion store and the second ion store accumulates a sample of fragmented precursor ions for analysis in a first mass analyser, wherein the fragmented precursor ions are formed from fragmentation of precursor ions having m/z values within the sub-range.

### CROSS REFERENCE TO RELATED APPLICATION

This application claims priority from GB 2400067.1, filed Jan. 3, 2024, which is incorporated herein by reference.

### FIELD

The field of this this invention is liquid chromatography mass spectrometry (LC-MS). In particular, this invention relates to tandem mass spectrometry where precursor ions and fragment ions are analysed. More particularly, the invention relates to improving the dynamic range of an MS1 scan in tandem mass spectrometry. The invention is relevant particularly, although not exclusively, to advanced hybrid mass spectrometers with multiple analysers.

### BACKGROUND

Standard tandem liquid chromatography mass spectrometry (LC-MS) methods include performing “MS1” scans, where ions having a wide range of m/z are analysed by a mass analyser to produce an MS1 spectrum (containing information about precursor ions). Methods of operating a LC-MS further involve the isolation and fragmentation of ions from eluted analyte species in order to perform “MS2” scans, where a narrow m/z range of ions is isolated (e.g., using a quadrupole mass filter), those ions are fragmented, and the fragment ions are mass analysed to produce an MS2spectrum, containing structural and quantitative information about fragment ions.

In LC-MS methods, multiple MS2 scans are typically performed during a chromatographic separation, where the m/z isolation range is different for each MS2 scan. The MS2 (or “MS/MS”) spectra are supported by the MS1 (or “MS” or “Full-MS”) survey scans, which provide high quality peak information such as accurate mass data and precursor intensity of a wide range of unfragmented precursor ions.

For Data Independent Acquisition (DIA) methods, the MS1 scan is optional and may be skipped to allow time to generate additional MS2 spectra. A list of m/z targets for each of the plural MS2 scans can be a stepwise increasing/decreasing list of m/z across an m/z range of interest. An example of this is described in EP 3,410,463, which is herein incorporated by reference. The resulting precursor information can be used for quantitation, while fragment information can be used for identification.

In Data Dependent Acquisition (DDA), the MS1 step is required to generate a list of precursor targets for MS2 analysis. The list of m/z targets for each of the plural MS2 scans corresponds to a list of precursors ions identified in an MS1 scan.

To mass analyse ions, ions (fragment ions or precursor ions) are commonly first accumulated in an ion trap, and then the accumulated ions are ejected as a packet into the mass analyser for mass analysis. Accumulation improves the sensitivity of the instrument but requires careful (so-called “Automatic Gain Control”, AGC) over the fill time of ions into the ion trap to avoid detrimental space charge effects.

One problem with existing methods is that the dynamic range of the MS1 spectrum is limited. Digested peptide concentration varies by more than 10 orders of magnitude depending on the sample, but the dynamic range of a single shot spectrum in, for example, a Fourier transform mass analyser, such as an electrostatic orbital trap mass analyser (e.g., an Orbitrap™ FT mass analyser made by Thermo Fisher Scientific™) may be limited to around 4 orders of magnitude. Furthermore, the number of ions that may be injected into the orbital trap mass analyser is limited by the capacity of the accumulating C-Trap to approximately 10⁵. Consequently, low intensity peptide precursor signals may be overwhelmed. For DDA experiments, these issues are significant and could result in precursor targets being missed. For DIA experiments, a lack of good precursor data hinders identification and quantitation.

One method to improve the dynamic range of the MS1 spectrum is the “Boxcar” method (as described in Meier et al, Nature Methods, 2018, 15, 440-448), and the high dynamic range (HDR) method described in UK Patent Application Number 2211790.7, which is herein incorporated by reference. In these approaches, the wide mass range of the analysis is subdivided into a number of narrower isolation windows. For each isolation window, a separate injection is made into the C-Trap, with a differing fill time dependent on the ion current. By this method heavily populated m/z regions are attenuated and sparsely populated m/z regions are amplified. Thus, detection sensitivity for relatively weak peaks is improved and the effective dynamic range of the scan is increased. However, use of these methods significantly increases the time required to accumulate ions, especially when a substantial number of isolation windows are required. Because of the long fill times for low-level windows, and the time required to switch the quadrupole and ion source voltages, HDR scanning may require a significant amount of additional time and impact the rate at which MS2 scans may be made. Therefore, these methods may decrease the time available for MS2 scans in fast LC-MS methods, which are limited by the time taken for the sample to elute from the chromatography column.

Multiple-window HDR methods also suffer from the drawback of discarding a considerable number of ions due to quadrupole isolation. Loss of ions may be addressed via a pre-accumulation process. For example, trapped ion mobility devices may be used to pre-accumulate ions prior to a quadrupole and release them in a mass/mobility dependent manner synchronized to the mass filter, greatly reducing ion losses (as described in Meier et al, Molecular & Cellular Proteomics, 2018, 17, 2524-2545).

Differential mobility filtration may be used to improve proteomics performance by removing analytically less useful singly charged ions from the accumulated population (as described in Hebert et al, Anal. Chem., 2018, 90, 9529-9537). This may be advantageous in low sample or single cell experiments, where the analyte signal is small in comparison to the singly charged solvent background signal. In DIA experiments, MS2 spectra may retain a proportion of unfragmented precursor ions (in quantities that are insufficient to be analytically useful). Some instruments offer an optional feature called “Stepped Collision Energy,” which is described in U.S. Pat. No. 9,536,717. This feature provides multiple separate injections into a collision cell (also referred to as a “fragmentation chamber”) at a range of collision energies, the summed population of ions are then transferred to the C-Trap/Fourier transform mass analyser and analysed together. This variation in energies improves the probability that one of the energies used is optimal for fragmenting the precursor ion. However, this approach also uses many collision energies that are not optimal for fragmenting the precursor ion, with the associated cost of ion beam time. The actual action of changing collision energy and making a second or third injection into a collision cell may not be overly time-intensive, perhaps an additional 1-3 ms overhead on a >40 ms scan cycle, in some cases.

U.S. Pat. No. 8,686,350 describes a method in which different types of ions can be accumulated in an ion trap before being ejected into a mass analyser. In one example, a combination of two types of ion with the same narrow mass range are injected into the ion trap, one fragmented and one left as intact precursor. This allows greater confidence that precursor ions may be detected and accurately mass measured. However, quantitation may suffer from the proportion of unfragmented precursor left over from the MS2 injection.

### SUMMARY

A method of mass spectrometry is provided. The method comprises the following steps for each of a plurality of sub-ranges selected from an overall m/z range:
configuring an ion beam switch to direct ions towards a first ion store;
accumulating in the first ion store a sample of precursor ions to be analysed, the precursor ions having m/z values within the sub-range.

In option a), the method further comprises (for each of the plurality of sub-ranges) configuring the ion beam switch to direct ions towards a first mass analyser and injecting a sample of fragmented precursor ions into the first mass analyser, wherein the sample of fragmented precursor ions are formed from fragmentation of precursor ions having m/z values within the sub-range.

In option b), the method further comprises (for each of the plurality of sub-ranges) configuring the ion beam switch to direct ions towards a second ion store and accumulating in the second ion store a sample of fragmented precursor ions for analysis in a first mass analyser, wherein the fragmented precursor ions are formed from fragmentation of precursor ions having m/z values within the sub-range.

The proposed method uses a branched ion beam path, provided by an ion beam switch, in a DIA method that intersperses MS2 and SIM injections, so that precursor ions for a HDR scan are built up in a first ion store, as the MS/MS spectra are generated (by analysis of the fragment ions). Beam switching in a vacuum enables fast transitions and short duty cycles, which is advantageous for intense ion peaks. While ion optics are known, the method of utilization of these devices for parallel accumulation of distinct ion populations made on the basis of the same quadrupole isolations is not found anywhere in the prior art.

Advantageously, the proposed methods facilitate a high quality HDR scan by accumulation of precursor ions from multiple injections. The injection times for each sub-range may be individually tailored to improve resolution. The overall time taken to obtain MS/MS spectra and HDR precursor scan data may be reduced, compared to separate MS1 and MS2 analysis.

The proposed methods are suitable for quantitation of a wide dynamic range of analyte ions. Performing separate MS1 and MS2 scans normally would involve prolonged delays to switch the ion source and quadrupole to scan through the mass range, independent of the DIA cycle for obtaining fragment data. The number of ions to be processed for an HDR scan is high and therefore always costs a substantial proportion of ion beamtime.

The fragmented precursor ions in the sample of fragmented precursor ions may be formed from fragmentation of precursor ions having m/z values within the sub-range. More specifically, the sample of fragmented precursor ions may consist of fragmented precursor ions formed from fragmentation of precursor ions having m/z values within the sub-range.

The sample of precursor ions may consist of precursor ions having m/z values within the sub-range.

The samples of precursor ions for each of the plurality of sub-ranges may be combined together in the first ion store, so that the first ion store contains precursor ions having m/z values from the overall m/z range. In other words, there may be ions from each sub-range in the first ion store.

The method may further comprise analysing the combined samples of precursor ions having m/z values from the overall m/z range in the first mass analyser or a second mass analyser. In other words, the plurality of SIM injections may be combined together in the first ion store and analysed together in a mass analyser. Whilst the precursor accumulation step is performed for each sub-range, the step of analysing the combined samples of precursor ions may be performed once for the overall m/z range.

In a first example, the method further comprises ejecting ions from the first ion store into a second mass analyser. In other words, there may be two mass analysers in tandem, both downstream of the ion beam switch.

In a second example, the first ion store is an intermediate ion store, wherein the method further comprises configuring the ion beam switch to transfer precursor ions accumulated in the first ion store to a third ion store for analysis in a second mass analyser.

The third ion store may be between an ion filter and the ion beam switch. Ions may be transferred from the ion filter to the ion beam switch via the third ion store.

The method may further comprise ejecting ions from the third ion store into the second mass analyser.

The precursor ions transferred from the first ion store to the third ion store may comprise the samples of precursor ions for each of the plurality of sub ranges.

In other words, in the second example, there may be two mass analysers in tandem, the first being downstream of the ion beam switch (for analysing the fragment ions, e.g., a time-of-flight mass analyser) and the second being upstream of the ion beam switch (for analysing the precursor ions, e.g., a Fourier transform mass analyser). Precursor ions may be transferred from the first ion store to the third ion store after the samples of fragmented precursor ions for each of the plurality of sub ranges have been accumulated in the second ion store. In other words, the precursor ions may be transferred away from the intermediate ion store after all the fragment ions have already been accumulated or analysed. This prevents the precursor ions accumulated in the intermediate ion store from mixing with other ions in the ion beam switch during the transfer.

The third ion store may be a curved linear ion trap (also called a “c-trap”).

To minimise overheads the beam switching device preferably exhibits relatively fast voltage transitions. The time taken to switch between ion destinations may be small compared with accumulation times for precursor and fragment ions. In some examples, the switching times are approximately 1 millisecond or less.

The ion beam switch may provide sufficient ion transport to eliminate mixing of ions between sub-ranges.

In some examples, a third ion store is provided upstream of the ion beam switch. In this case, ions may be first accumulated in the third ion store, prior to the switching region (such as in the C-Trap). This configuration may allow parallelisation of accumulation (in the C-trap) with ion transport via the ion beam switch of the immediately preceding sub-range. In other words, after precursor ions from a first sub-range have all been ejected from the third ion store, accumulation of precursor ions from the next sub-range in the third ion store may begin, while the precursor ions from the first sub-range are being transported via the ion beam switch. This improves overall performance, even if the switching process were relatively slow.

The second mass analyser may be a Fourier transform mass analyser. This applies to the first example and the second example describe above.

In a third example, the first ion store may be an intermediate ion store. The method may further comprise configuring the ion beam switch to transfer precursor ions accumulated in the first ion store to the first mass analyser (in option a) or the second ion store (in option b).

Where the ion beam switch is configured to direct ions towards the second ion store, the sample of precursor ions is accumulated in the second ion store and precursor ions are transferred to the second ion store (option b), the method may further comprise ejecting the precursor ions from the second ion store into the first mass analyser.

The precursor ions transferred from the first ion store (to either the first mass analyser or the second ion store) may comprise the samples of precursor ions for each of the plurality of sub ranges.

The transferred precursor ions may comprise precursor ions having m/z values from the overall m/z range. In other words, the transferred precursor ions may comprise the combined samples from each sub-range.

Where the ion beam switch is configured to direct ions towards the second ion store and the sample of fragmented precursor ions is accumulated in the second ion store (option b), the method may further comprise ejecting the sample of fragmented precursor ions from the second ion store into the first mass analyser.

The sample of fragmented precursor ions may be ejected from the second ion store after each accumulation (before accumulation of fragment ions formed from fragmentation of precursor ions from the next sub-range).

The sample of fragmented precursor ions may be ejected from the second ion store before the precursor ions are transferred to the second ion store.

The precursor ions may be transferred from the first ion store to the second ion store after the samples of fragmented precursor ions for each of the plurality of sub ranges have been ejected from the second ion store into the first mass analyser.

In some examples, the ion beam switch is between an ion filter and the first ion store and between the ion filter and the second ion store and configured to (alternately) direct ions from the ion filter to the first ion store and the second ion store.

For each sub-range the step of accumulating the sample of precursor ions may be performed prior to the step of accumulating the sample of fragmented precursor ions. Alternatively, for each sub-range, the step of accumulating the sample of fragmented precursor ions may be performed prior to the step of accumulating the sample of precursor ions.

The method may further comprise, for each of the plurality of sub-ranges, analysing the sample of the precursor ions in the first mass analyser or a second mass analyser. In this alternative, the precursor ions for each sub-range are analysed separately in a SIM scan, rather than accumulating all the SIM injections together and analysing the precursor ions from the overall m/z range in one scan. The SIM scans may be interleaved with the fragment scans, which may advantageously mean that reconfiguration of the ion filter is not required between the SIM scan and fragment scan for each sub-range. The method may further comprise obtaining scan data relating to the precursor ions for each sub-range. The method may further comprise combining the scan data relating to the precursor ions for each sub-range to form a high-definition scan for the overall m/z range. In other words, the SIM scan data is stitched together to provide a high-resolution MS scan. A pre-scan may not be needed in this case (since the sub-ranges are contiguous and cover the overall m/z range).

In another example, the HDR MS scan could be split into a plurality of scans, each of the plurality of scans relating to precursor ions from a plurality of contiguous sub-ranges. In this alternative, each scan comprises simultaneous analysis of multiple SIM injections. The method may further comprise combining the scan data from each of the plurality of scans to form a high-definition scan for the overall m/z range. A pre-scan may not be needed in this case because a) the sub-ranges are contiguous and cover the overall m/z range and b) each of the sub-ranges is analysed in a corresponding one of the plurality of scans.

The ion beam switch may be configured to operate under pure molecular flow conditions. Pure molecular flow conditions (also called free molecular flow or Knudsen diffusion) are observed when the Knudsen number, Kn, is greater than 20 or more preferably Kn>10.

The method may further comprise fragmenting the precursor ions to produce the sample of fragmented precursor ions.

Where the ion beam switch is configured to direct ions towards the second ion store and the sample of fragmented precursor ions is accumulated in the second ion store (option b), the ions may be fragmented in the second ion store.

In other words, precursor ions may be directed by the ion beam switch to the second ion store and then the ions may be fragmented once they have been accumulated in the second ion store.

Alternatively, the ions may be fragmented using a multipole collision cell (e.g., an IRM collision cell).

The multipole collision cell may be upstream of the ion beam switch, so that the ion beam switch directs fragmented precursor ions to the first mass analyser (in option a) or the second ion store (in option b). In some examples, the multipole collision cell may be between the ion filter (where present) and the ion beam switch.

Alternatively, the multipole collision cell may be downstream of the ion beam switch so that the ion beam switch directs precursor ions to the multipole collision cell, which then transfers fragmented ions to the first mass analyser (in option a) or second ion store (in option b). In other words, in option a), the multipole collision cell may be between the ion beam switch and the first mass analyser or, in option b), the multipole collision cell may be between the ion beam switch and the second ion store. In option b), the fragmented ions may be accumulated in the second ion store, and then ejected from the second ion store into the first mass analyser. The method may further comprise, for each of the plurality of sub-ranges, configuring an ion filter to transmit precursor ions having m/z values within the sub-range. The sample of precursor ions may be received from the configured ion filter. The sample of fragmented precursor ions may be formed from fragmentation of precursor ions received from the configured ion filter.

In other words, the ion filter may not be reconfigured between filling the first ion store and the second ion store.

The sample of fragmented precursor ions may be formed from fragmentation of precursor ions received from the configured ion filter via the ion beam switch (where fragmentation occurs downstream of the ion beam switch). Alternatively, the sample of fragmented precursor ions may be formed from fragmentation of precursor ions received from the configured ion filter and then the sample of fragmented precursor ions may be transferred via the ion beam switch (where fragmentation occurs upstream of the ion beam switch).

Configuring the ion filter may comprise setting a transmission window of the ion filter. The transmission window may be adjusted between each of the plurality of sub-ranges. For each sub-range, the transmission window for the step of accumulating the sample of precursor ions may be the same as the transmission window for the step of injecting the sample of fragmented precursor ions into the first mass analyser (in option a) or accumulating the sample of fragmented precursor ions in the second ion store (in option b).

A front-end accumulation device, such as an ion mobility separator such as a Trapped Ion Mobility Separator (as incorporated into the Bruker TIMS-ToF series of mass spectrometers), may be used (and would be advantageous to the methods described herein). Such a device may release ions in an m/z range synchronised to the quadrupole isolation window. As a result, ion transmission is greatly boosted. As a further result, the required injection time may be reduced (due to a brighter isolated ion beam). This reduction in injection time may be used to offset the additional time overhead of the SIM injections.

The method may further comprise configuring an ion mobility separator to transfer precursor ions having m/z values within the sub-range to the ion filter.

The method may further comprise controlling the ion mobility separator so that the precursor ions transferred to the ion filter correspond with a transmission window of the ion filter, for each of the plurality of sub-ranges in the overall m/z range.

Accumulating the sample of precursor ions may comprise controlling a fill time for the precursor ions, based on a relative abundance of precursor ion species in the corresponding sub-range.

Where the ion beam switch is configured to direct ions towards the second ion store and the sample of fragmented precursor ions is accumulated in the second ion store (option b), the method may further comprise, for each of the plurality of sub-ranges, ejecting the sample of fragmented precursor ions into the first mass analyser and analysing the sample of fragmented precursor ions in the first mass analyser. The plurality of sub-ranges may comprise a first sub-range and a second sub-range.

The step of analysing the sample of fragmented precursor ions from the first sub-range may at least partially overlap (in time) with the step of accumulating, in the second ion store, the sample of fragmented precursor ions formed from fragmentation of precursor ions having m/z values within the second sub-range.

Where the ion beam switch is configured to direct ions towards the first mass analyser (option a), the method may further comprise analysing the sample of fragmented precursor ions in the first mass analyser.

The step of analysing the sample of fragmented precursor ions from the first sub-range may at least partially overlap (in time) with the step of accumulating the sample of precursor ions having m/z values within the second sub-range in the first ion store.

The first mass analyser may be a time-of-flight, ToF, analyser.

The first mass analyser may be a multi-reflection time-of-flight, MR-ToF, analyser.

The first ion store may be a curved linear trap (e.g., a c-trap). Where the ion beam switch is configured to direct ions towards the second ion store and the sample of fragmented precursor ions is accumulated in the second ion store (option b), the second ion store may be a linear trap (e.g., a DP-R Trap). The method may further comprise ionising the sample to produce the precursor ions.

The sample of fragmented precursor ions may be formed from fragmentation of precursor ions having m/z values within the sub-range at a plurality of different collision energies.

The method may further comprise:
configuring an ion filter to transmit precursor ions having m/z values from the overall m/z range;
transferring an initial sample of precursor ions having m/z values from the overall m/z range to the first mass analyser or a second mass analyser; analysing the initial sample of precursor ions; and
obtaining scan data for the overall m/z range from analysis of the initial sample of precursor ions.

In other words, the method may comprise a pre-scan of the overall m/z range, prior to analysis of ions from the plurality of sub-ranges (e.g., an AGC pre-scan). Optionally, the method may comprise accumulating (in a single fill and in either the first ion store or the second ion store) the initial sample of precursor ions having m/z values from the overall m/z range. Alternatively, the initial sample may be directed to the first mass analyser or the second mass analyser. Analysing the initial sample of precursor ions having m/z values from the overall m/z range may comprise obtaining scan data for the overall m/z range (which may be low-resolution, full-MS scan data, rather than SIM scan data).

The method may further comprise determining the plurality of sub-ranges from the overall m/z range, based on the scan data obtained from analysis of the initial sample of precursor ions (having m/z values from the overall m/z range). This may be referred to as a Data Dependent Acquisition, DDA, method.

Each of the plurality of sub-ranges may have the same width.

The plurality of sub-ranges may be contiguous.

The method may be performed within a time period based on a width of a chromatographic peak of the sample as it elutes from a chromatography system.

In another example, a method of mass spectrometry is also provided. The method comprises the following steps for each of a plurality of sub-ranges selected from an overall m/z range:
configuring an ion beam splitter to direct ions towards a first ion destination and a second ion destination, wherein the first ion destination is a first ion store;
accumulating in the first ion store a sample of precursor ions to be analysed, the precursor ions having m/z values within the sub-range.

In option a), the second ion destination is a first mass analyser and the method further comprises (for each of the plurality of sub-ranges) injecting a sample of fragmented precursor ions into the first mass analyser, wherein the sample of fragmented precursor ions are formed from fragmentation of precursor ions having m/z values within the sub-range.

In option b), the second ion destination is a second ion store, and the method further comprises (for each of the plurality of sub-ranges) accumulating in the second ion store a sample of fragmented precursor ions for analysis in a first mass analyser, wherein the sample of fragmented precursor ions are formed from fragmentation of precursor ions having m/z values within the sub-range.

The proposed method facilitates splitting an ion beam proportionally, based on the spatial distribution of the ion beam. The split ion beam may be used for creation of parallel accumulation regions for simultaneous accumulation of precursor ions (SIM injections) for a HDR MS1 scan, alongside a series of MS2 scans.

The methods described here may be used to build up a high quality HDR scan using a Fourier transform mass analyser (or equivalent precursor data from a plurality of MS1 scans, where each scan spans a plurality of sub-ranges).

The proposed methods are suitable for quantitation of a wide dynamic range of analyte ions. Performing separate MS1 and MS2 scans normally would involve prolonged delays to switch the ion source and quadrupole to scan through the mass range, independent of the DIA cycle for obtaining fragment data. The number of ions to be processed for an HDR scan is high and therefore always costs a substantial proportion of ion beamtime.

The fragmented precursor ions in the sample of fragmented precursor ions may be formed from fragmentation of precursor ions having m/z values within the sub-range. More specifically, the sample of fragmented precursor ions may consist of fragmented precursor ions formed from fragmentation of precursor ions having m/z values within the sub-range.

The sample of precursor ions may consist of precursor ions having m/z values within the sub-range.

The samples of precursor ions for each of the plurality of sub-ranges may be combined together in the first ion store, so that the first ion store contains precursor ions having m/z values from the overall m/z range. In other words, there may be ions from each sub-range in the first ion store.

The method may further comprise analysing the combined samples of precursor ions having m/z values from the overall m/z range in the first mass analyser or a second mass analyser. In other words, the plurality of SIM injections may be combined together in the first ion store and analysed together in a mass analyser. Whilst the precursor accumulation step is performed for each sub-range, the step of analysing the combined samples of precursor ions may be performed once for the overall m/z range.

In a first example, the method further comprises ejecting ions from the first ion store into a second mass analyser. In other words, there may be two mass analysers in tandem, both downstream of the ion beam splitter.

In a second example, the first ion store is an intermediate ion store, wherein the method further comprises configuring the ion beam splitter to transfer precursor ions accumulated in the first ion store to a third ion store for analysis in a second mass analyser.

The third ion store may be between an ion filter and the ion beam splitter (specifically, the input region of the ion beam splitter). Ions may be transferred from the ion filter to the ion beam splitter via the third ion store.

In this case, ions may be transferred from the first “outlet” region to the “inlet” region. Therefore, in the step of transferring precursor ions accumulated in the first ion store to the third ion store, the first outlet region may function as an inlet and the first inlet region may function as an outlet. In other words, the ions travel in the reverse direction to normal.

The method may further comprise ejecting ions from the third ion store into the second mass analyser.

The precursor ions transferred from the first ion store to the third ion store may comprise the samples of precursor ions for each of the plurality of sub ranges. In other words, in the second example, there may be two mass analysers in tandem, the first being downstream of the ion beam splitter (for analysing the fragment ions, e.g., a time-of-flight mass analyser) and the second being upstream of the ion beam splitter (for analysing the precursor ions, e.g., a Fourier transform mass analyser).

Precursor ions may be transferred from the first ion store to the third ion store after the samples of fragmented precursor ions for each of the plurality of sub ranges have been accumulated in the second ion store. In other words, the precursor ions may be transferred away from the intermediate ion store after all the fragment ions have already been accumulated or analysed. This prevents the precursor ions accumulated in the intermediate ion store from mixing with other ions in the ion beam splitter during the transfer.

The third ion store may be a curved linear ion trap (also called a “c-trap”).

The ion beam splitter may provide sufficient ion transport to eliminate mixing of ions between sub-ranges.

In some examples, a third ion store is provided upstream of the ion beam splitter. In this case, ions may be first accumulated in the third ion store, prior to the ion beam splitter (such as in the C-Trap). This configuration may allow parallelisation of accumulation (in the C-trap) with ion transport via the ion beam splitter of the immediately preceding sub-range. In other words, after precursor ions from a first sub-range have all been ejected from the third ion store, accumulation of precursor ions from the next sub-range in the third ion store may begin, while the precursor ions from the first sub-range are being transported via the ion beam splitter. This improves overall performance, even if the time taken for ions to be cleared out of the ion beam splitter were relatively slow.

The second mass analyser may be a Fourier transform mass analyser. This applies to the first example and the second example describe above.

In a third example, the first ion store may be an intermediate ion store. The method may further comprise configuring the ion beam splitter to transfer precursor ions accumulated in the first ion store to the second ion destination (e.g., the first mass analyser in option a) or the second ion store in option b).

In this case, ions may be transferred from the first “outlet” region to the second outlet region. Therefore, in the step of transferring precursor ions accumulated in the first ion store to the second ion destination, the first outlet region may function as an inlet.

Where the second ion destination is a second ion store (option b), the method may further comprise ejecting the precursor ions from the second ion store into the first mass analyser.

The precursor ions transferred from the first ion store (to either the first mass analyser or the second ion store) may comprise the samples of precursor ions for each of the plurality of sub ranges.

The transferred precursor ions may comprise precursor ions having m/z values from the overall m/z range. In other words, the transferred precursor ions may comprise the combined samples from each sub-range.

Where the second ion destination is a second ion store (option b), the method may further comprise ejecting the sample of fragmented precursor ions from the second ion store into the first mass analyser.

The sample of fragmented precursor ions may be ejected from the second ion store after each accumulation (before accumulation of fragment ions formed from fragmentation of precursor ions from the next sub-range).

The sample of fragmented precursor ions may be ejected from the second ion store before the precursor ions are transferred to the second ion store.

The precursor ions may be transferred from the first ion store to the second ion store after the samples of fragmented precursor ions for each of the plurality of sub ranges have been ejected from the second ion store into the first mass analyser.

The first ion store may be provided by a DC barrier adjacent the first output region. In other words, the first ion store (intermediate ion store) may be integral to the ion beam splitter.

In some examples, the ion beam splitter is between an ion filter and the first ion destination and between the ion filter and the second ion destination and configured to (simultaneously) direct ions from the ion filter to the first ion destination and the second ion destination.

For each sub-range the step of accumulating the sample of precursor ions may be performed prior to the step of accumulating the sample of fragmented precursor ions.

Alternatively, for each sub-range, the step of accumulating the sample of fragmented precursor ions may be performed prior to the step of accumulating the sample of precursor ions.

The method may further comprise, for each of the plurality of sub-ranges, analysing the sample of the precursor ions in the first mass analyser or a second mass analyser. In this alternative, the precursor ions for each sub-range are analysed separately in a SIM scan, rather than accumulating all the SIM injections together and analysing the precursor ions from the overall m/z range in one scan. The SIM scans may be interleaved with the fragment scans, which may advantageously mean that reconfiguration of the ion filter is not required between the SIM scan and fragment scan for each sub-range. The method may further comprise obtaining scan data relating to the precursor ions for each sub-range. The method may further comprise combining the scan data relating to the precursor ions for each sub-range to form a high-definition scan for the overall m/z range. In other words, the SIM scan data is stitched together to form a high-resolution MS scan. A pre-scan may not be needed in this case (since the sub-ranges are contiguous and cover the overall m/z range).

In another example, the HDR MS scan could be split into a plurality of scans, each of the plurality of scans relating to precursor ions from a plurality of contiguous sub-ranges. In this alternative, each scan comprises simultaneous analysis of multiple SIM injections. The method may further comprise combining the scan data from each of the plurality of scans to form a high-definition scan for the overall m/z range. A pre-scan may not be needed in this case because a) the sub-ranges are contiguous and cover the overall m/z range and b) each of the sub-ranges is analysed in a corresponding one of the plurality of scans.

The ion beam splitter may be configured to operate under pure molecular flow conditions. Pure molecular flow conditions (also called free molecular flow or Knudsen diffusion) are observed when the Knudsen number, Kn, is greater than 20 or more preferably Kn>10.

The method may further comprise fragmenting the precursor ions to produce the sample of fragmented precursor ions.

Where the second ion destination is the second ion store (option b), the ions may be fragmented in the second ion store.

In other words, precursor ions may be directed by the ion beam splitter to the second ion store and then the ions may be fragmented once they have been accumulated in the second ion store.

Alternatively, the ions may be fragmented using a multipole collision cell (e.g., an IRM collision cell).

The multipole collision cell may be downstream of the ion beam splitter so that the ion beam splitter directs precursor ions to the multipole collision cell, which then transfers fragmented ions to the second ion destination (the first mass analyser in option a) or the second ion store in option b). In other words, the multipole collision cell may be between the ion beam switch and the second ion destination.

In option b), the fragmented ions may be accumulated in the second ion store, and then ejected from the second ion store into the first mass analyser.

The method may further comprise, for each of the plurality of sub-ranges, configuring an ion filter to transmit precursor ions having m/z values within the sub-range. The sample of precursor ions may be received from the configured ion filter. The sample of fragmented precursor ions may be formed from fragmentation of precursor ions received from the configured ion filter.

In other words, the ion filter may be configured once per sub-range and that configuration is suitable for filling the first ion store with precursor ions and sending fragmented precursor ions to the second ion destination (simultaneously using the ion beam splitter).

The sample of fragmented precursor ions may be formed from fragmentation of precursor ions received from the configured ion filter via the ion beam splitter. Configuring the ion filter may comprise setting a transmission window of the ion filter. The transmission window may be adjusted between each of the plurality of sub-ranges. For each sub-range, the transmission window for the step of accumulating the sample of precursor ions may be the same as the transmission window for the step of injecting the sample of fragmented precursor ions into the first mass analyser (in option a) or accumulating the sample of fragmented precursor ions in the second ion store (in option b).

A front-end accumulation device, such as an ion mobility separator such as a Trapped Ion Mobility Separator (as incorporated into the Bruker TIMS-ToF series of mass spectrometers), may be used (and would be advantageous to the methods described herein). Such a device may release ions in an m/z range synchronised to the quadrupole isolation window. As a result, ion transmission is greatly boosted. As a further result, the required injection time may be reduced (due to a brighter isolated ion beam). This reduction in injection time may be used to offset the additional time overhead of the SIM injections.

The method may further comprise configuring an ion mobility separator to transfer precursor ions having m/z values within the sub-range to the ion filter.

The method may further comprise controlling the ion mobility separator so that the precursor ions transferred to the ion filter correspond with a transmission window of the ion filter, for each of the plurality of sub-ranges in the overall m/z range.

Accumulating the sample of precursor ions may comprise controlling a fill time for the precursor ions, based on a relative abundance of precursor ion species in the corresponding sub-range.

Where the second ion destination is a second ion store and the sample of fragmented precursor ions is accumulated in the second ion store (option b), the method may further comprise, for each of the plurality of sub-ranges, ejecting the sample of fragmented precursor ions from the second ion store into the first mass analyser and analysing the sample of fragmented precursor ions in the first mass analyser. The plurality of sub-ranges may comprise a first sub-range and a second sub-range.

The step of analysing the sample of fragmented precursor ions from the first sub-range may at least partially overlap (in time) with the step of accumulating, in the second ion store, the sample of fragmented precursor ions formed from fragmentation of precursor ions having m/z values within the second sub-range.

Where the second ion destination is a first mass analyser and the sample of fragmented precursor ions are injected into the first mass analyser (option a), the method may further comprise analysing the sample of fragmented precursor ions in the first mass analyser.

The step of analysing the sample of fragmented precursor ions from the first sub-range may at least partially overlap (in time) with the step of accumulating the sample of precursor ions having m/z values within the second sub-range in the first ion store.

The first mass analyser may be a time-of-flight, ToF, analyser. The first mass analyser may be a multi-reflection time-of-flight, MR-ToF, analyser.

The first ion store may be a curved linear trap (e.g., a c-trap).

Where the second ion destination is a second ion store and the sample of fragmented precursor ions is accumulated in the second ion store (option b), the second ion store may be a linear trap (e.g., a DP-R Trap).

The method may further comprise ionising the sample to produce the precursor ions.

The sample of fragmented precursor ions may be formed from fragmentation of precursor ions having m/z values within the sub-range at a plurality of different collision energies.

The method may further comprise:
configuring an ion filter to transmit precursor ions having m/z values from the overall m/z range;
transferring an initial sample of precursor ions having m/z values from the overall m/z range to the first mass analyser or a second mass analyser; analysing the initial sample of precursor ions; and
obtaining scan data for the overall m/z range from analysis of the initial sample of precursor ions.

In other words, the method may comprise a pre-scan of the overall m/z range, prior to analysis of ions from the plurality of sub-ranges (e.g., an AGC pre-scan). Optionally, the method may comprise accumulating (in a single fill and in either the first ion store or the second ion store) the initial sample of precursor ions having m/z values from the overall m/z range. Alternatively, the initial sample may be directed to the first mass analyser or the second mass analyser. To transport the initial sample of ions, the ion beam splitter may be configured so that substantially all of the ions are directed towards one outlet region (and negligible ions towards the other outlet region). Analysing the initial sample of precursor ions having m/z values from the overall m/z range may comprise obtaining scan data for the overall m/z range (which may be low-resolution, full-MS scan data, rather than SIM scan data).

The method may further comprise determining the plurality of sub-ranges from the overall m/z range, based on the scan data obtained from analysis of the initial sample of precursor ions (having m/z values from the overall m/z range). This may be referred to as a Data Dependent Acquisition, DDA, method.

Each of the plurality of sub-ranges may have the same width.

The plurality of sub-ranges may be contiguous.

The method may be performed within a time period based on a width of a chromatographic peak of the sample as it elutes from a chromatography system. In yet another example, a method of mass spectrometry is provided comprising the following steps for each of a plurality of sub-ranges selected from an overall m/z range:
configuring an ion guide to direct ions towards a first ion destination and/or a second ion destination, wherein the first ion destination is a first ion store; accumulating in the first ion store a sample of precursor ions to be analysed, the precursor ions having m/z values within the sub-range.

In option a), the second ion destination is a first mass analyser, and the method further comprises (for each of the plurality of sub-ranges) injecting a sample of fragmented precursor ions into the first mass analyser, wherein the sample of fragmented precursor ions are formed from fragmentation of precursor ions having m/z values within the sub-range.

In option b), the second ion destination is a second ion store, and the method further comprises accumulating in the second ion store a sample of fragmented precursor ions to be analysed, the sample of fragmented precursor ions being formed from fragmentation of precursor ions having m/z values within the sub-range.

The ion guide may be an ion beam splitter or an ion beam switch.

The ion guide may have an inlet region for receiving ions, a first outlet region for directing ions to the first ion destination and a second outlet region for directing ions to the second ion destination.

A mass spectrometer configured to perform a method described above is also provided.

The mass spectrometer may comprise an ion guide, a first ion destination and a second ion destination.

Computer software comprising instructions that, when executed by the processor of a computer, cause the computer to perform a method described above is also provided.

The instructions may be executed by the processor of a controller of a mass spectrometer, causing the mass spectrometer to perform the method.

In yet a further example, there is also provided an ion guide with a switchable ion path for a mass spectrometer. The ion guide comprises a first ion transport aperture configured to receive an ion beam. The ion guide further comprises a radio frequency surface comprising a plurality of radio frequency electrodes arranged on a first surface, such that the plurality of radio frequency electrodes are parallel to each other. The ion guide further comprises a radio frequency voltage source configured to apply an alternating radio frequency phase to each of the plurality of radio frequency electrodes. The ion guide further comprises a DC potential source configured to apply a DC gradient across the radio frequency surface, wherein the DC gradient is configured to guide an ion beam via either a first ion path or a second ion path. The ion guide further comprises a second ion transport aperture and a third ion transport aperture. Ions travelling in the first ion path are directed between the first ion transport aperture and the second ion transport aperture and ions travelling in the second ion path are directed between the first ion transport aperture and the third ion transport aperture.

In this way the ions may be trapped within a large volume over the radio frequency surface. The ions may be gently guided by the DC gradient to follow either the first ion path (between the first ion transport aperture and the second ion transport aperture) or the second ion path (between the first ion transport aperture and the third ion transport aperture).

A DC gradient is particularly desirable in systems operating at higher pressures (or lower vacuums) due to the lower mean-free path of the ions. The ions may be stopped in flight by excess collisions with background gas. These ions may then fail to reach the analyser in a timely manner, resulting in losses or in the ions reaching the analyser for the wrong measurement. Ions that linger in the ion guide may create unwanted space charge effects for other ions in flight. A DC gradient may help to ensure that the ions are removed from the ion guide and reach the analyser, reducing transmission losses and transit time losses.

The DC gradient may comprise an orthogonal component and an axial component.

In this way the DC gradient may guide the ion beam to follow either the first ion path or the second ion path using the orthogonal component, and may guide the ion beam from one end of the ion guide to the other using the axial component.

The second ion transport aperture and the third ion transport aperture may be in a first plane and the orthogonal component of the DC gradient may be parallel to the first plane and the axial component of the DC gradient may be parallel to a direction of a shortest distance from the first ion transport aperture to the first plane.

In this way the DC gradient may guide the ion beam to follow either the first ion path or the second ion path using the orthogonal component, and may guide the ion beam from one end of the ion guide to the other (i.e. between the first ion transport aperture and a plane intersecting the second ion transport aperture and the third ion transport aperture) using the axial component.

The radio frequency electrodes may comprise elongated electrode plates arranged such that the plane of each plate is parallel to the plane of the adjacent plate. Advantageously, the electrode plates may prevent ions from approaching the first surface.

The radio frequency electrodes may be arranged in a grid.

In this way, the radio frequency electrodes may be used to apply a DC gradient or travelling wave in both the axial and orthogonal directions.

The ion guide may comprise a top plate configured to apply a repelling voltage that repels the ion beam towards the radio frequency surface.

In this way the ions may be compressed close to the radio frequency surface.

The top plate may comprise the DC potential source, wherein the DC potential source may be configured to apply the DC gradient to the top plate.

In this way the top plate may be configured to apply the DC gradient.

The top plate may comprise a PCB and a plurality of DC electrodes printed on the PCB.

Advantageously, the DC electrodes may be printed in shapes that allow DC gradients to be applied. If the top plate is configured to apply a repelling voltage and the top plate comprises DC electrodes printed on the PCB, the repelling voltage keeps the ions from approaching the PCB.

The plurality of DC electrodes may be arranged in a grid.

In this way a two-dimensional DC gradient may be applied.

The plurality of DC electrodes may be arranged in a horseshoe configuration, wherein prongs of the horseshoe are adjacent to the second ion transport aperture and the third ion transport aperture.

In this way the shape of the DC electrodes may help define the first ion path and the second ion path.

The plurality of DC electrodes may be connected by resistors.

In this way a DC gradient may be applied.

The DC potential source may comprise a plurality of auxiliary DC electrodes, wherein each auxiliary DC electrode is positioned between radio frequency electrodes.

In this way the radio frequency electrodes and the DC potential source may both be arranged on or adjacent to the first surface.

The plurality of auxiliary DC electrodes may comprise elongated electrode plates and the radio frequency electrodes may comprise elongated electrode plates arranged such that the plane of each plate is parallel to the plane of the adjacent plate, wherein the planes of the plates of the DC electrodes are parallel to the planes of the plates of the adjacent radio frequency electrodes.

In this way the DC electrodes may be mounted between the radio frequency electrodes, and may apply a strong enough DC gradient to reach the centre of the ion guide.

The auxiliary DC electrodes may comprise elongated electrode plates that are wedge-shaped in the plane of the plates.

In this way the DC electrodes may apply a DC gradient.

Each of the plurality of DC electrodes may comprise a peak and a trough in the top of the plate.

In this way the ion beam may be spatially focussed as the ions travel along the first ion path or the second ion path.

The radio frequency electrodes may comprise elongated electrode plates arranged such that the plane of each plate is parallel to the plane of the adjacent plate and the first surface may comprise a PCB wherein the auxiliary DC electrodes comprise printed electrodes between the radio frequency electrodes.

In this way the DC electrodes may be printed between the radio frequency electrodes.

The ion guide may comprise a top surface facing the radio frequency surface comprising a plurality of radio frequency electrodes arranged on the top surface; and a plurality of auxiliary DC electrodes, each of the plurality of auxiliary DC electrodes mounted between radio frequency electrodes.

In this way both the first surface and the top surface may comprise electrodes that provide a pseudopotential surface and apply a DC gradient.

The radio frequency electrodes may comprise elongated electrode plates arranged such that the plane of each plate is parallel to the plane of the adjacent plate, wherein each of the radio frequency electrodes may comprise a first indent and a second indent in the top of the radio frequency electrodes, wherein the first indents and second indents coincide with the position of the first ion path and the second ion path and wherein the first indents and second indents increase in depth towards the second ion transport aperture and the third ion transport aperture.

In this way the ion beam may be spatially focussed as the ions travel along the first ion path or the second ion path.

The ion guide may further comprise a first side guard positioned on a first side of the radio frequency surface and a second side guard positioned on a second side of the radio frequency surface.

In this way ions may be prevented from leaking out of the sides of the ion guide. The first and second side guards may be configured to prevent ions exiting the ion guide via the first side or the second side, and/or to shape the ion cloud.

The first and second side guards may comprise a first wall and a second wall. In this way ions and buffer gas may be physically prevented from leaking out of the sides of the ion guide.

The first and second side guards may comprise a first guard electrode and a second guard electrode, wherein the first and second guard electrode are configured to receive either a repulsive DC voltage or an attractive DC voltage.

In this way if a repulsive DC voltage is applied the ions may be repelled from the sides of the ion guide to keep the ions within the main volume of the ion guide as they travel between the first ion transport aperture and the second or third ion transport aperture. If an attractive DC voltage is applied, the ion cloud may be pulled towards edges of the radio frequency electrodes, helping to focus the ion beam.

The first surface may be configured to form the first and second side guards. In this way separate side guards may not be required.

The radio frequency electrodes may be configured to form the first and second side guards.

Advantageously, the radio frequency electrodes may repel the ions away from the sides of the ion guide.

The first surface may be inclined relative to the top plate or top surface, such that the distance between the first surface and the top plate or top surface decreases closer to the second ion transport aperture and the third ion transport aperture.

In this way the ion beam may be spatially focussed as the ions travel from the first ion transport aperture to the second or third ion transport aperture.

The ion guide may further comprise a bin opposite to the first ion transport aperture, wherein the bin is configured to receive undeflected components of the ion beam.

In this way neutrals, droplets or other unwanted material may be removed from the ion guide.

### BRIEF DESCRIPTION OF THE DRAWINGS

The invention may be put into practice in a number of ways and specific embodiments will now be described by way of example only and with reference to the following Figures.

FIG. 1 shows a schematic diagram of a mass spectrometer suitable for carrying out methods in accordance with embodiments.

FIG. 2 illustrates a branched RF multipole that may be used as an ion beam switch.

FIG. 3 shows a schematic diagram of an ion guide comprising a radio frequency (RF) surface comprising a plurality of RF electrodes comprising elongated electrode plates, according to an embodiment of the present disclosure.

FIG. 4 shows a schematic diagram of RF electrodes of an ion guide, wherein the RF electrodes comprise indents forming a channel, according to an embodiment of the present disclosure.

FIGS. 5A-5D show schematic diagrams of a cross section of an ion guide according to an embodiment of the present disclosure. FIG. 5A shows an RF electrode, a top plate, a first side guard and a second side guard. FIG. 5B shows an RF electrode and a top plate, wherein the RF electrode comprises a first side guard and a second side guard. FIG. 5C shows an RF electrode and a top plate, wherein the RF electrode comprises a first side guard, a second side guard, a first indent and a second indent. FIG. 5D shows an RF electrode, a top plate, a first DC electrode and a second DC electrode, wherein the RF electrode comprises a first side guard and a second side guard.

FIG. 6 shows a schematic diagram of an ion guide according to an embodiment of the present disclosure, wherein the ion guide comprises a radio frequency (RF) surface comprising a plurality of RF electrodes, and a top plate comprising a DC electrode structure.

FIG. 7 shows a schematic diagram of a DC electrode structure according to an embodiment of the present disclosure, wherein the DC electrode structure comprises a grid of printed electrodes.

FIG. 8 shows a schematic diagram of a DC electrode structure according to an embodiment of the present disclosure, wherein the DC electrode structure comprises a horseshoe shape of printed electrodes.

FIG. 9 shows a schematic diagram of an ion guide according to an embodiment of the present disclosure, wherein the ion guide comprises a radio frequency (RF) surface comprising a plurality of RF electrodes, and a plurality of auxiliary DC electrodes mounted between the RF electrodes.

FIG. 10 shows a schematic diagram of an ion guide according to an embodiment of the present disclosure, wherein the ion guide comprises a radio frequency (RF) surface comprising a plurality of RF electrodes, and a plurality of auxiliary DC electrodes mounted between the RF electrodes and wherein the ion guide further comprises a top surface comprising a plurality of RF electrodes and a plurality of auxiliary DC electrodes mounted between the RF electrodes.

FIG. 11 shows a schematic of a cross section of an auxiliary DC electrode according to an embodiment of the present disclosure.

FIG. 12 shows a schematic diagram of an ion guide according to an embodiment of the present disclosure, wherein the ion guide comprises a radio frequency (RF) surface comprising a plurality of RF electrodes, and a plurality of auxiliary DC electrodes printed between the RF electrodes.

FIG. 13 shows a schematic diagram of a mass spectrometer incorporating an ion guide according to an embodiment of the present disclosure.

FIGS. 14A-14B illustrate two alternative configurations of a hybrid mass spectrometer incorporating a beam switching device. FIG. 14A illustrates a configuration in which the beam switch is located after the quadrupole mass filter. FIG. 14B illustrates a configuration in which the beam switching device is located after the curved linear ion store.

FIG. 15 illustrates an ion beam splitting device based on an RF carpet ion guide.

FIGS. 16A-16B illustrate two alternative configurations of hybrid mass spectrometer incorporating a beam splitting device.

FIG. 17 illustrates a DIA method for parallel accumulation of SIM injections in a curved linear ion store, building to a single HDR scan using a Fourier transform mass analyser, interleaved between a series of MS2 scans in a time-of-flight mass analyser.

### DETAILED DESCRIPTION

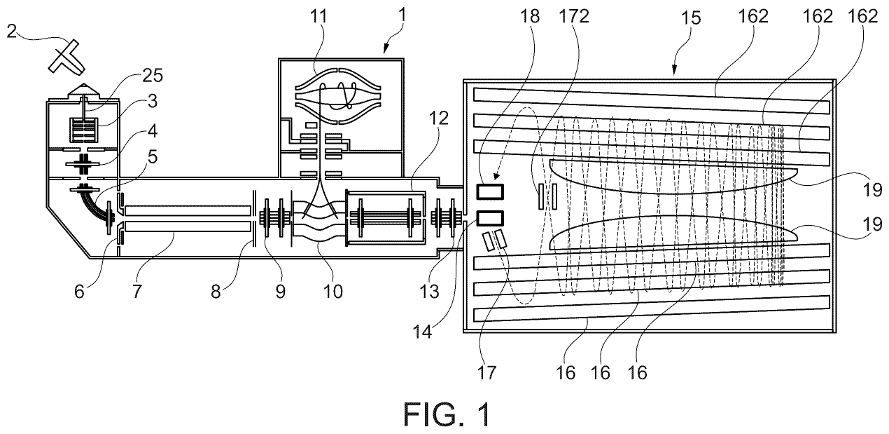

FIG. 1 shows a schematic arrangement of a mass spectrometer 1 suitable for carrying out methods in accordance with embodiments. The mass spectrometer 1 may be a Hybrid Fourier transform/multi-reflection time-of-flight mass spectrometer (MR-ToF) described in U.S. Pat. No. 10,699,888, which is incorporated by reference. The details of the mass analyser are described in U.S. Pat. No. 9,136,101, which is herein incorporated by reference. In FIG. 1, a sample to be analysed is supplied (for example from an autosampler) to a chromatographic apparatus such as a liquid chromatography (LC) column (not shown in FIG. 1). One such example of an LC column is the Thermo Fisher Scientific, Inc ProSwift™ monolithic column which offers high performance liquid chromatography (HPLC) through the forcing of the sample carried in a mobile phase under high pressure through a stationary phase of irregularly or spherically shaped particles constituting the stationary phase. In the HPLC column, sample molecules elute at different rates according to their degree of interaction with the stationary phase.

A chromatograph may be produced by measuring over time the quantity of sample molecules that elute from the HPLC column using a detector (for example a mass spectrometer). Sample molecules which elute from the HPLC column will be detected as a peak above a baseline measurement on the chromatograph. Where different sample molecules have different elution rates, a plurality of peaks on the chromatograph may be detected. Preferably, individual sample peaks are separated in time from other peaks in the chromatogram such that different sample molecules do not interfere with each other.

On a chromatograph, a presence of a chromatographic peak corresponds to a time period over which the sample molecules are present at the detector. As such, a width of a chromatographic peak is equivalent to a time period over which the sample molecules are present at a detector. Preferably, a chromatographic peak has a Gaussian shaped profile, or can be assumed to have a Gaussian shaped profile. Accordingly, a width of the chromatographic peak can be determined based on a number of standard deviations calculated from the peak. For example, a peak width may be calculated based on 4 standard deviations of a chromatographic peak. Alternatively, a peak width may be calculated based on the width at half the maximum height of the peak. Other methods for determining the peak width known in the art may also be suitable.

The sample molecules thus separated via liquid chromatography are then ionized using an electrospray ionization source (ESI source) 2 which is at atmospheric pressure.

Sample ions then enter a vacuum chamber of the mass spectrometer 1 and are directed by a capillary 25 into an RF-only S lens 3 (also called an ion funnel). The ions are focused by the S lens 3 into an injection flatapole 4 (also called a quadrupole pre-filter) which injects the ions into a bent flatapole 5 with an axial field. The bent flatapole 5 guides (charged) ions along a curved path through it whilst unwanted neutral molecules such as entrained solvent molecules are not guided along the curved path and are lost. The curved path may be a 90-degree bend or an s-shaped wiggle, for example.

A TK lens 6 located at the distal end of the bent flatapole 5. Ions pass from the bent flatapole 5 into a downstream mass selector in the form of a quadrupole mass filter 7. The TK lens acts as a fringe field corrector for the quadrupole mass filter 7. The quadrupole mass filter 7 is typically but not necessarily segmented and serves as a band pass filter, allowing passage of a selected mass number or limited mass range whilst excluding ions of other mass to charge ratios (m/z). The mass filter can also be operated in an RF-only mode in which it is not mass selective, i.e. it transmits substantially all m/z ions. For example, the quadrupole mass filter 7 may be controlled by the controller to select a range of mass to charge ratios to pass of the precursor ions which are allowed to pass, whilst the other ions in the precursor ion stream are filtered (attenuated). Alternatively, the S lens 3 may be operated as an ion gate and the ion gate (TK lens) 6 may be a static lens.

Although a quadrupole mass filter is shown in FIG. 1, the skilled person will appreciate that other types of mass selection devices may also be suitable for selecting precursor ions within the mass range of interest. For example, an ion separator as described in US-A-2015/0287585, an ion trap as described in WO-A-2013/0076307, an ion mobility separator as described in US-A-2012/256083, an ion gate mass selection device as described in WO-A-2012/175517, or a charged particle trap as described in U.S. Pat. No. 7,999,223, which is herein incorporated by reference. The skilled person will appreciate that other methods selecting precursor ions according to ion mobility, differential mobility and/or transverse modulation may also be suitable.

The isolation of a plurality of ions of different masses or mass ranges may also be performed using the method known as synchronous precursor scanning (SPS) in an ion trap. Furthermore, in some embodiments, more than one ion selection or mass selection device may be provided. For example, a further mass selection device may be provided downstream of the fragmentation chamber 12. In this way, MS³ or MSⁿ scans can be performed if desired (typically using the ToF mass analyser for mass analysis).

Ions then pass through a quadrupole exit lens/split lens arrangement 8 that acts as an ion gate to control the passage of ions into a first transfer multipole 9, optionally via a charge detector (not illustrated). The first transfer multipole 9 guides the mass filtered ions from the quadrupole mass filter 7 into a curved linear ion trap (C-trap) 10. The C-trap (first ion store) 10 has longitudinally extending, curved electrodes which are supplied with RF voltages and end caps that to which DC voltages are supplied. The result is a potential well that extends along the curved longitudinal axis of the C-trap 10. In a first mode of operation, the DC end cap voltages are set on the C-trap so that ions arriving from the first transfer multipole 9 are captured in the potential well of the C-trap 10, where they are cooled. The injection time (IT) of the ions into the C-trap determines the number of ions (ion population) that is subsequently ejected from the C-trap into the mass analyser.

Cooled ions reside in a cloud towards the bottom of the potential well and are then ejected orthogonally from the C-trap towards the second mass analyser 11. As shown in FIG. 1, the second mass analyser is a Fourier transform mass analyser, such as an orbital trapping mass analyser 11, for example the Orbitrap™ mass analyser sold by Thermo Fisher Scientific, Inc. The Fourier transform mass analyser 11 has an off centre injection aperture and the ions are injected into the orbital trapping mass analyser 11 as coherent packets, through the off centre injection aperture. Ions are then trapped within the orbital trapping mass analyser by a hyperlogarithmic electric field, and undergo back and forth motion in a longitudinal direction whilst orbiting around the inner electrode.

The axial (z) component of the movement of the ion packets in the orbital trapping mass analyser is (more or less) defined as simple harmonic motion, with the angular frequency in the z direction being related to the square root of the mass to charge ratio of a given ion species. Thus, over time, ions separate in accordance with their mass to charge ratio.

Ions in the orbital trapping mass analyser are detected by use of an image current detector (not shown) which produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing abundance/ion intensity versus m/z, can be produced.

In the configuration described above, the sample ions (more specifically, a mass range segment of the sample ions within a mass range of interest, selected by the quadrupole mass filter 7) are analysed by the orbital trapping mass analyser 11 without fragmentation. The resulting mass spectrum is denoted MS1.

Although an orbital trapping mass analyser 11 is shown in FIG. 1, other mass analysers including other Fourier Transform mass analysers may be employed instead. For example, a Fourier Transform Ion Cyclotron Resonance (FTICR) mass analyser may be utilised as mass analyser for the MS1 scans. Mass analysers, such as the orbital trapping mass analyser and Ion Cyclotron Resonance mass analyser, may also be used in embodiments even where other types of signal processing than Fourier transformation are used to obtain mass spectral information from the transient signal (see for example WO 2013/171313, Thermo Fisher Scientific).

In a second mode of operation of the C-trap 10, ions passing through the quadrupole exit lens/split lens arrangement 8 and first transfer multipole 9 into the C-trap 10 may also continue their path through the C-trap and into the fragmentation chamber 12, which may be an “Ion Routing Multipole” (IRM) collision cell. As such, the C-trap effectively operates as an ion guide in the second mode of operation. Alternatively, cooled ions in the C-trap 10 may be ejected from the C-trap in an axial direction into the fragmentation chamber 12. The fragmentation chamber 12 is, in the mass spectrometer 1 of FIG. 1, a high energy collisional dissociation (HCD) device to which a collision gas is supplied. Precursor ions arriving into the fragmentation chamber 12 collide with collision gas molecules resulting in fragmentation of the precursor ions into fragment ions.

Although an HCD fragmentation chamber 12 is shown in FIG. 1, other fragmentation devices may be employed instead, employing such methods as collision induced dissociation (CID), electron capture dissociation (ECD), electron transfer dissociation (ETD), photodissociation, and so forth. Moreover, ion fragmentation may be performed in a high pressure region of the extraction trap 14.

Fragmented ions may be ejected from the fragmentation chamber 12 at the opposing axial end to the C-trap 10. The ejected fragmented ions pass into a second transfer multipole 13. The second transfer multipole 13 guides the fragmented ions from the fragmentation chamber 12 into an extraction trap (second ion trap) 14. The extraction trap 14 is a radio frequency voltage controlled trap containing a buffer gas. For example, a suitable buffer gas is argon at a pressure in the range 5×10⁻⁴ mBar to 1×10⁻² mBar. The extraction trap has the ability to quickly switch off the applied RF voltage and apply a DC voltage to extract the trapped ions. A suitable flat plate extraction trap, also referred to as a rectilinear ion trap, is further described in U.S. Pat. No. 9,548,195, which is herein incorporated by reference. Alternatively, a C-trap may also be suitable for use as a second ion trap.

The extraction trap 14 is provided to form an ion packet of fragmented ions, prior to injection into the time-of-flight mass analyser 15. The extraction trap 14 accumulates fragmented ions prior to injection of the fragmented ions into the time-of-flight mass analyser 15.

Although an extraction trap (ion trap) is shown in the embodiment of FIG. 1, the skilled person will appreciate that other methods of forming an ion packet of fragmented ions will be equally suitable for embodiments. For example, relatively slow transfer of ions through a multipole can be used to affect bunching of ions, which can subsequently be ejected as a single packet to the ToF mass analyser. Alternatively orthogonal displacement of ions may be used to form a packet. Further details of these alternatives are found in US 2003/0001088 which describes a travelling wave ion bunching method, which is herein incorporated by reference.

In FIG. 1, the time-of-flight mass analyser 15 shown is a multiple reflection time-of-flight mass analyser (MR-ToF) 15. The MR-ToF 15 is constructed around two opposing ion mirrors 16, 162, elongated in a drift direction. The mirrors are opposed in a direction that is orthogonal to the drift direction. The extraction trap 14 injects ions into the first mirror 16 and the ions then oscillate between the two mirrors 16, 162. The angle of ejection of ions from the extraction trap 14 and additional deflectors 17, 172 allow control of the energy of the ions in the drift direction, such that ions are directed down the length of the mirrors 16, 162 as they oscillate, producing a zig-zag trajectory. The mirrors 16, 162 themselves are tilted relative to one another, producing a potential gradient that retards the ions' drift velocity and causes them to be reflected back in the drift dimension and focused onto a detector 18. The tilting of the opposing mirrors would normally have the negative side-effect of changing the time period of ion oscillations as they travel down the drift dimension. This is corrected with a stripe electrode 19 (to act as a compensation electrode) that alters the flight potential for a portion of the inter-mirror space, varying down the length of the opposing mirrors 16, 162. The combination of the varying width of the stripe electrode 19 and variation of the distance between the mirrors 16, 162 allows the reflection and spatial focusing of ions onto the detector 18 as well as maintaining a good time focus. A suitable MR-ToF 15 for use in embodiments is further described in US 2015/028197 (A1), which is herein incorporated by reference.

In one example, an MS1 scan may be performed by the second mass analyser (e.g., the orbital trapping mass analyser 11). In a second example, precursor ions may be fragmented and MS2 scans may be performed by the second mass analyser (the orbital trapping mass analyser 11) or the first mass analyser (the time-of-flight mass analyser), depending on whether the fragmentation chamber is controlled to eject the ions back towards the C-trap 10 or forwards to the second transfer multipole 13. In a further mode of operation, the second mass analyser (time-of-flight mass analyser 15) may perform MS1 scans of ions. In this mode of operation the ions are directed axially through the C-trap 10 to the fragmentation chamber, but without sufficient kinetic energy to cause fragmentation and the ions are guided to the second transfer multipole 13 without fragmentation. The ions can then be accumulated into packets in the extraction trap 14, as described above.

Ions accumulated in the extraction trap are injected into the MR-ToF analyser 15 as a packet of ions, once a predetermined number of ions have been accumulated in the extraction trap. By ensuring that each packet of ions injected into the MR-ToF 15 has at least a predetermined (minimum) number of ions, the resulting packet of ions arriving at the detector will be representative of the entire mass range of interest of the MS1 or MS2 spectrum. A single packet of precursor ions or fragmented ions is sufficient to acquire MS1 or MS2 spectra of the respective ions. For MS2, this represents an increased sensitivity compared to conventional acquisition of time-of-flight spectra in which multiple spectra typically are acquired and summed for each given mass range segment. Preferably, a minimum total ion current (TIC) in each mass window is accumulated in the extraction trap before ejection to the time-of-flight mass analyser. In some examples, at least N spectra (scans) are acquired per second in the MS2 domain by the time-of-flight mass analyser, wherein N=50, or more preferably 100, or 200, or more.

Preferably, at least X % of the MS2 scans contain more than Y ion counts (wherein X=30, or 50, or 70, or most preferably 90, or more, and Y=200, or 500, or 1000, or 2000, or 3000, or 5000, or more). Most preferably, at least 90% of the MS2 scans contain more than 500 ion counts, or more preferably more than 1000 ion counts, and ideally more than 5000 ion counts. This provides for an increased dynamic range of MS2 spectra. The desired ion counts for each of the MS2 scans may be provided by adjusting the number ions included in each packet of fragmented ions. For example, in the embodiment of FIG. 1, the accumulation time of the extraction trap may be adjusted to ensure that a sufficient number of ions have been accumulated. As such, the controller may be configured to determine that a suitable packet of fragmented ions has been formed when either a predetermined number of ions are present in the extraction trap, or a predetermined period of time has passed. The predetermined period of time may be specified in order to ensure that the time-of-flight mass analyser operates at the desired frequency when the flow of ions to the extraction trap is relatively low.

The mass spectrometer 1 is under the control of a controller which, for example, is configured to control the timing of ejection of the trapping components, to set the appropriate potentials on the electrodes of the quadrupole etc so as to focus and filter the ions, to capture the mass spectral data from the orbital trapping device 11, to capture the mass spectral data from the MR-ToF 15, control the sequence of MS1 and MS2 scans and so forth. It will be appreciated that the controller may comprise a computer that may be operated according to a computer program comprising instructions to cause the mass spectrometer to execute the steps of the method according to embodiments.

It is to be understood that the specific arrangement of components shown in FIG. 1 is not essential to the methods subsequently described. Indeed, other arrangements for carrying out the methods of embodiments are suitable. In some examples, all scans (MS1, MS2 and/or SIM) are performed by the MR-ToF analyser, which is faster than the orbital trapping analyser.

A front-end accumulation device, such as an ion mobility separator (e.g., a Trapped Ion Mobility Separator, TIMS), may be configured to release ions in an m/z range corresponding to the quadrupole isolation window. A result of this is to improve ion transmission of the quadrupole filter. As a further result of the ion mobility separator, the required injection time may be reduced (due to the isolated ion beam being brighter). This reduction in injection time may be used to at least partially offset the additional time overhead of the SIM injections.

An ion mobility separator may comprise a stacked ring ion guide, which applies a DC gradient push ions in one direction, opposed by a gas wind in the opposing direction.

In one example of an ion mobility separator, an electric field barrier in a gas flow is used to hold back ions according to their ion mobility. A decrease of the field barrier releases ions with increasing ion mobility.

The TIMS is described in detail in documents U.S. Pat. Nos. 7,838,826, 9,891,194 and Meier et al., 2018, Molecular & Cellular Proteomics 17, 2534-2545, which are herein incorporated by reference.

An extended ion funnel is comprised of a multitude of segmented electrodes, which are assembled about a common axis. The extended ion guide can be treated as three sections:
an entrance focusing section,
a mobility analysis section, and
an exit focusing section.

In the focusing sections, the distances between adjacent electrodes are approximately equal to the thickness of the electrodes. The diameter of the apertures in the electrodes is a function of the position of the electrode in the ion funnel assembly.

For example, the segmented electrode having the largest aperture is at entrance end of the ion funnel and the segmented electrode having the smallest aperture is at the exit end of the ion funnel.

In some examples, the aperture diameter may be a linear function of the segmented electrode's position. In other examples, this function may be non-linear. The angle formed between common axis and the inner boundary (i.e., formed by the inner rims of the segmented electrodes) of the ion funnel may be approximately 19°. However, any angle between 0° and 90° may be used.

In the mobility analysis section of the ion funnel, the segmented electrodes may all have the same inner diameter. The space between adjacent electrodes may be filled with dielectric or electrically resistive gaskets. The thickness of the segmented electrodes should be smaller than its inner diameter and the spacing between the electrodes should be smaller than the thickness of the segmented electrodes to maintain a uniform RF field, so that the axial DC field is homogeneous near the axis.

Gaskets or o-rings between the electrodes form a substantially air tight seal so that the apertures in the electrodes form a gas tight channel through which gas may flow. Gas enters the channel in the entrance focussing section, forms a laminar stream that flows uniformly through the mobility analysis section, is constricted through the exit focusing section and then flows out through the aperture in the final electrode. The apertures are substantially cylindrically symmetric to maintain a cylindrically symmetric flow profile. In operation, a symmetric laminar flow of gas means that all ions of a given type at a given position along the axis will experience a given force due to the gas flow, substantially independent of their lateral position with respect to the axis.

A quadrupole ion filter comprises four rods equally spaced at a predetermined radius around a central axis. A radio frequency, RF, (e.g. a 1 MHz sine wave) potential is applied between the rods. The potential on adjacent rods is 180° out of phase. Rods on opposite sides of the axis of quadrupole are electrically connected, so that the quadrupole is formed as two pairs of rods. Ions travel along the axis of quadrupole and exit the quadrupole through an aperture. The RF potential applied between the rods tends to confine the ions radially. When only RF is applied between the rods, substantially all ions are transmitted through the quadrupole. Applying a DC as well as an RF potential between the pairs of rods causes ions of only a limited mass range to be transmitted through quadrupole. Ions outside this mass range are filtered away and do not reach the exit end.

The DC electric field strength varies as a function of position along the axis. However, at some position in analysis section, the field strength reaches a maximum so as to form a barrier which ions must overcome in order to reach the exit end of the funnel. Near this position of maximum field strength, the uniformity of the DC field is important because this is the point at which ions are selected on the basis of their mobility. The DC field should therefore be cylindrically symmetric.

An example method of operation comprises the steps of:
forming a DC barrier in the analysis section;
applying an RF field for focusing ions towards the axis;
generating ions in an ion source;
introducing ions in a carrier gas into the extended ion funnel;
introducing ions into the focusing section by applying potentials to the electrodes of the focusing section and/or the deflection electrode;
transferring ions into the analysis section by applying DC potentials to the electrodes of the focusing section;
optionally preventing additional ions from entering the analysis section by applying DC potentials to the deflection electrode and/or the electrodes of the focusing section;
inducing a carrier gas flow through the channel using a pump downstream from the exit end of the funnel;
gradually reducing the DC barrier in the analysis section to allow the carrier gas flow to push ions from the group of ions over the DC barrier in order of the ions' mobilities; and
focusing ions through the aperture in the exit electrode.

In another example, a DC gradient is used to push ions out, opposed by a gas wind. As the DC potential is increased, ions are released in order of mobility. In one example method, a full mass scan is performed by the Fourier transform mass analyser 11 with a long acquisition transient, generating high-resolution MS1 spectra. In parallel to this, the MR-ToF 15 analyser performs a series of MS2 acquisitions with very fast scanning speed and high sensitivity.

An example method for combined ion injection and analysis is described in U.S. Pat. No. 8,686,350, which is herein incorporated by reference.

An example method described herein accumulates different types of ions with two injections: a first injection of ions that have been fragmented and a second injection of ions that are left as intact precursor ions (the first and second ion injections may be performed in either order). The ions may come from the same ion source and with the same quadrupole isolation window but with different fragmentation energies (a collision energy of zero for the precursor injection). The fragment ions are analysed in a mass analyser to provide fragment spectra. The precursor ions are accumulated in an ion store and combined with precursor ions from other quadrupole isolation windows. The combined precursor ions are then analysed in a mass analyser to provide analytical scan data. Such scan data provides precursor information, in addition to the fragment spectra. The precursor ion accumulation may be performed quickly alongside the usual MS2 fragment analysis, as there is no additional quadrupole switching time, and the additional inject time for the precursor ion (SIM) component should be lower than for the fragmentation injection.

Where analysis is to be performed using a hybrid instrument, such as the one illustrated in FIG. 1, it is preferable that the SIM components (the unfragmented precursor ions for each sub-range) are measured in a high resolution MS1 scan. To perform this, it is necessary to separate the unfragmented SIM component from the fragmented MS2 component and then collect them for separate analysis. The path to the fragment analyser (the first analyser) analyser must not be blocked by built up SIM-injection ions. One way to accomplish this is to create a branched ion path, so that SIM ions may be split off and sent to one region, whilst MS2 scans are acquired in parallel. In some examples, ions may be split between two separate ion destinations via the use of a beam switching device to create a branched ion path. A switchable-path ion guide is described in UK Patent Application Number 2209555.8, which is herein incorporated by reference. Other suitable devices are described in patent publications U.S. Pat. No. 7,829,850B2, US2019/0103261A1, U.S. Pat. No. 8,581,181B2 and U.S. Pat. No. 9,984,861B2.

Ion beam switching devices exist in the prior art. Many of these involve switching in RF gas-filled multipoles, which are slow due to ion diffusion in gas and cannot operate with transition times at low-microsecond scale. Such devices might be compatible with the proposed methods. In which case, ions are preferably decelerated prior to entrance to the RF gas-filled guide, to reduce unwanted fragmentation in the guide. However, it is preferable to instead provide an ion beam switch that operates under pure molecular flow conditions (with Kn>10-20).

In one example, a two-plate gate could be used for switching, preferably following ion acceleration in the range of 10-50 V, to reduce ion losses. Preferably, such a gate is located in the 10⁻⁴ to 10⁻⁵ mbar pressure region and is spatially separated from RF gas-filled guides. This reduces the probability of ion-molecule collisions and corresponding losses, at the same time providing reduced switching times that are important for intense ion beams from modern ion sources.

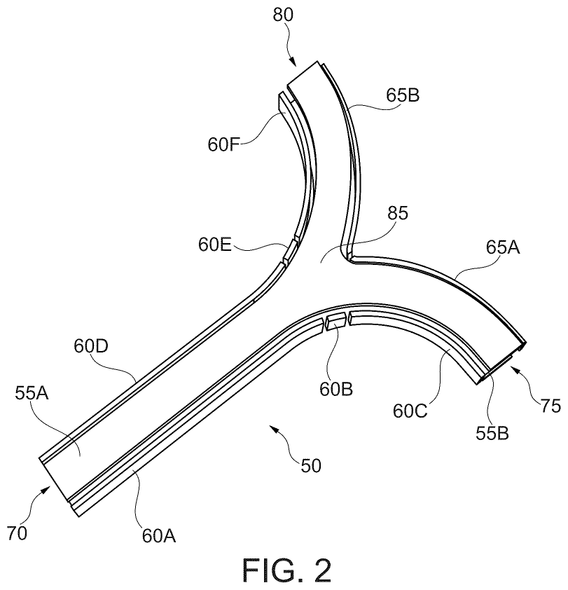

The branched RF multipole described in U.S. Pat. No. 7,829,850B2 may be suitable as an ion beam switch. This device, illustrated in FIG. 2, is an RF quadrupole that may cause ions to move down one channel or the other by switching RF phase, amplitude or by applying a DC gradient. The device is compatible with a high vacuum and thus ions may be transferred quickly without diffusion and thus with minimum time penalties induced by path switching or ion transit.

FIG. 2 illustrates a perspective view of the branched radio frequency multipole system described in U.S. Pat. No. 7,829,850B2. Branched radio frequency multipole system 50 comprises branched electrodes 55A and 55B, disposed parallel to each other. Branched radio frequency multipole system also comprises orthogonal electrodes 60A, 60B, 60C, 60D, 60E, 60F, 65A, and 65B. The orthogonal electrodes 60A-60F, 65A, and 65B are disposed orthogonally to the branched electrodes 55A and 55B such that the branched radio frequency multipole 50 comprises a first ion channel between ports 70 and 75 and a second ion channel between ports 70 and 80 of branched radio frequency multipole 50. Port 70 is an opening defined by the branched electrodes 55A and 55B and the orthogonal electrodes 60A and 60D. Port 75 is an opening defined by the branched electrodes 55A and 55B and the orthogonal electrodes 60C and 65A. Port 80 is an opening defined by the branched electrodes 55A and 55B and the orthogonal electrodes 60F and 65B. The first ion channel and the second ion channel overlap in part of the branched radio frequency multipole 50 adjacent to port 70 and diverge at a branch point 85 before continuing to port 75 and port 80, respectively.

The RF voltages applied to orthogonal electrodes 60B, 60C and 65A may be controlled such that the first ion channel comprising a path between port 70 and port 75 is opened. Alternatively, the RF voltages applied to orthogonal electrodes 60E, 60F, and 65B may be controlled such that the second ion channel comprising a path between port 70 and port 80 is opened. Thus, the paths by which ions traverse branched radio frequency multipole 50 can be controlled by the selection of appropriate voltages.

In another example described in UK Patent Application Number 2209555.8, an ion guide with a switchable ion path comprises a first ion transport aperture configured to receive an ion beam. The ion guide comprises a radio frequency (RF) surface comprising a plurality of radio frequency electrodes arranged on a first surface, such that the plurality of RF electrodes are parallel to each other. The RF surface may also be referred to as a radio frequency carpet. The ion guide further comprises a radio frequency voltage source configured to apply an alternating radio frequency phase to each of the plurality of RF electrodes. The ion guide further comprises a DC potential source configured to apply a DC gradient across the RF surface, wherein the DC gradient is configured to guide an ion beam via either a first ion path or a second ion path. The ion guide further comprises a second ion transport aperture and a third ion transport aperture, wherein ions travelling in the first ion path are directed to the second ion transport aperture and ions travelling in the second ion path are directed to the third ion transport aperture.

In the following, the term “DC potential source” refers to any source of a DC electric potential. A voltage may be applied to the DC potential source to produce the electric potential (or electric field). The voltage may be applied using a DC voltage source. The DC potential source may comprise electrodes, to which the voltage may be applied to produce a DC electric potential. The DC gradient may be applied using the radio frequency electrodes (so that the RF electrodes comprise the DC potential source) by applying a DC voltage gradient to the radio frequency electrodes. Otherwise, the DC gradient may be applied using auxiliary DC electrodes (wherein the auxiliary DC electrodes comprise the DC potential source).

In use, the ion guide may be configured to receive an ion beam via the first ion transport aperture. The DC gradient may be configured to guide the ion beam via either the first ion path or the second ion path, such that the ions of the ion beam exit the ion guide via either the second ion transport aperture or the third ion transport aperture. The DC gradient may be configured to split the ion beam into a first portion and a second portion, and to guide the first portion of the ion beam along the first ion path (such that the first portion exits the ion guide via the second ion transport aperture) and the second portion of the ion beam along the second ion path (such that the second portion exits the ion guide via the third ion transport aperture). Otherwise, the ion guide may be configured to receive an ion beam via the second ion transport aperture and/or the third ion transport aperture. The DC gradient may be configured to guide ions entering the ion guide via the second ion transport aperture along the first ion path such that the ions are directed to the first ion transport aperture and exit the ion guide via the first ion transport aperture. The DC gradient may be configured to guide ions entering the ion guide via the third ion transport aperture along the second ion path such that the ions are directed to the first ion transport aperture and exit the ion guide via the first ion transport aperture.

For conciseness, most of the following description assumes that ion guide is configured to receive the ion beam via the first ion transport aperture, and that the ion beam exits the ion guide via the second ion transport aperture and/or the third ion transport aperture. The first ion transport aperture is referred to as the inlet, the second ion transport aperture is referred to as the first exit aperture and the third ion transport aperture is referred to as the second exit aperture. However, any of the examples described below may be used in both directions (either such that the ion beam travels from the first ion transport aperture to the second ion transport aperture and/or the third ion transport aperture, or in the reverse direction, such that the ion beam or ion beams travel from the second ion transport aperture and/or the third ion transport aperture to the first ion transport aperture). Moreover, a downstream (or upstream) stage may be contiguous to the ion guide so that the “ion transport aperture” of the ion guide would be more accurately considered as an “ion transport region”, such as an inlet region or an outlet region. For example, if one path led to a trapping region built into the ion guide, an “aperture” may not be provided. Nevertheless, the specific examples will be described below with reference to apertures, for simplicity.

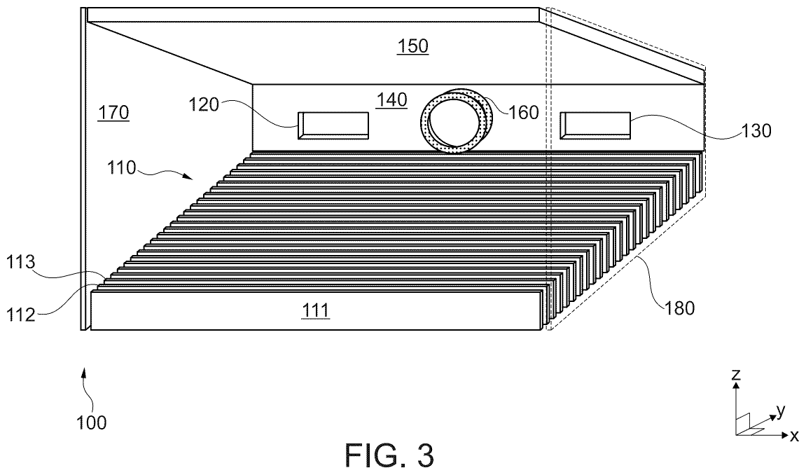

With reference to FIG. 3, an ion guide 100 is shown in accordance with an embodiment of the present disclosure. The ion guide 100 will be described with reference to the axes shown in FIG. 3. The ion guide comprises a front end comprising the first ion transport aperture (inlet) and a back wall 140 comprising the second ion transport aperture (first exit aperture) 120 and the third ion transport aperture (second exit aperture) 130. The front end may be open (such that the first ion transport aperture covers the entire front end) or may comprise a wall comprising the first ion transport aperture.

The RF surface 110 comprises a plurality of RF electrodes arranged to be parallel to one another. In use, opposing radio frequency phases may be applied to alternating RF electrodes in series (such that each RF electrode has an opposing RF phase to its neighbours), creating a repulsive pseudopotential surface. In the embodiment illustrated in FIG. 3, the RF electrodes comprise elongated electrode plates, wherein the planes of each of the plurality of plates are parallel to one another (and to the z-x plane as indicated by the axes in FIG. 3). The first three RF electrodes are labelled as 111, 112 and 113 to illustrate the arrangement. The remaining RF electrodes are not labelled. There may be more or fewer RF electrodes than shown in FIG. 3. In an embodiment, the RF surface 110 may comprise 50 RF electrodes comprising elongated electrode plates. The first surface may be perpendicular to the planes of each of the plurality of plates (and so parallel to the x-y plane) or may be at an angle A to the planes of each of the plurality of plates (so that the first surface is at an angle (90-A)° to the x-y plane). The angle A may, for example, be between 45° and 90°, or may be any other angle.

In another embodiment, the RF surface may comprise a plurality of printed RF electrodes on a PCB. In another embodiment, the RF electrodes may comprise electrodes formed on a substrate, for example by lithography.

In a specific example where the RF electrodes comprise elongated plates, the RF electrodes may comprise a thickness of between 0.5 mm and 1.5 mm and a separation of between 0.5 mm and 1.5 mm. The RF electrodes may comprise other thicknesses or separations. The applied RF voltages may be between 20 and 2000 V with frequencies of between 1 and 3 MHz. the applied RF voltages may have other magnitudes or frequencies. The internal volume of the ion guide may be approximately 100 cm³, wherein the dimensions are approximately 10 cm by 10 cm by 1 cm. However, this is a specific example and the ion guide may have any internal volume. In certain embodiments where the RF electrodes comprise PCB printed electrodes (or electrodes formed on a substrate by means such as lithography), the electrodes may be smaller and more closely spaced than described above. The thickness and spacing of the RF electrodes may be of the order of 10 μm, with an applied RF voltage that may have a frequency of at least 10 MHz. The thickness and spacing of the RF electrodes may be larger than 10 μm, for example between 10 μm and 1 mm.

The ion guide 100 further comprises the first exit aperture 120 and the second exit aperture 130. The ion guide may comprise the back wall 140 comprising the first and second exit apertures 120 and 130. In use, an ion beam may enter the ion guide 100 via an inlet at the front end of the ion guide 100 that is opposite to the back wall (the front end may be open or may comprise an aperture through which the ion beam enters the ion guide 100). The ions may be guided to either the first exit aperture 120 or the second exit aperture 130 by a DC gradient applied by the DC potential source. The RF surface 110 acts as the ion trapping region, while the DC gradient is superimposed on the RF field to guide ions to a selected exit aperture so that the ions are trapped and guided within a large volume. The DC gradient may comprise a component that guides the ion beam left or right (i.e., in either x direction) to follow the first ion path or the second ion path (referred to as orthogonal DC), but may also comprise a component that accelerates the ions beam from the front end of the ion guide towards the back wall of the ion guide (referred to as axial DC).

The first exit aperture 120 and the second exit aperture 130 may comprise physical apertures to define the maximum extent of the output channel for the ion beam. The first exit aperture 120 and the second exit aperture 130 may comprise physical apertures and may be further defined by electric field(s), so that the first exit aperture 120 and the second exit aperture 130 are defined by physical apertures and by electric fields. The first exit aperture 120 and the second exit aperture 130 may be defined by electric field(s) without a physical aperture. In an embodiment where the first exit aperture 120 and the second exit aperture 130 are defined by electric field(s) without a physical aperture, the back wall may comprise an opening, wherein the opening may extend across all or part of the back wall. The first and second exit apertures 120 and 130 may also have DC voltages applied to them. The DC voltages applied to the first and second exit apertures 120 and 130 may be equal or separate. The DC voltages may be configured to trap or admit ions, for example as required by downstream elements of a mass spectrometer. The DC voltages may be variable.

The ion guide 100 may further comprise a top plate 150 opposite to the RF surface 110. The top plate 150 may be parallel to the RF surface 110 or at an angle to the RF surface 110. The top plate 150 may be parallel to the x-y plane or at an angle to the x-y plane. The top plate 150 may comprise a ground plate or a repeller plate. In the event that the top plate 150 comprises a repeller plate, the repeller plate may be configured to confine the ion beam close to the RF surface. The repeller plate may comprise a repulsive DC electrode (i.e. a DC electrode to which a DC voltage can be applied to repel the ion beam). The repeller plate may be configured to prevent the ion beam from approaching the repeller plate, avoiding contamination and charging effects on the repeller plate. In an embodiment, the ion beam may be kept at least 5 mm from the repeller plate.

The back wall 140 may optionally further comprise a bin 160. The bin 160 may be positioned between the first exit aperture 120 and the second exit aperture 130. In an event that an ion beam is admitted to the ion guide 100 along with a stream of neutrals and/or charged droplets or other unwanted materials, the bin 160 may be configured to receive the stream of neutrals and/or charged droplets or other unwanted materials. The bin 160 may comprise a cylinder that is open at the ion guide end of the cylinder and closed at the opposing end of the cylinder, so that the bin 160 is configured to receive the unwanted materials, and to retain the unwanted materials in the bin 160. Otherwise, the bin 160 may comprise an aperture or other exit component configured to receive the unwanted materials and allow the unwanted materials to exit the ion guide 100. A pump may be used to aid removal of the unwanted materials from the ion guide via the bin 160.

In certain embodiments, the ion guide 100 may comprise a first side guard and a second side guard. The first and second side guards may be configured to prevent ions from exiting the ion guide 100 via the first (left) side or the second (right) side. The first side and second side each extend between the front end and the back wall 140, and each of the first side and second side may be open, closed, or partially open. The first side and second side may be parallel to one another or at an angle to one another. The first side and second side may be parallel to the z axis. The first side guard and second side guard may comprise first and second guard electrodes respectively. The first and second guard electrodes may be mounted at the first and second sides of the ion guide 100. A small repulsive DC voltage may be applied to the first and second guard electrodes to repel ions from the first side and the second side. The voltage applied to the first and second side guards may be used in combination with the DC gradient to define the maximum sideways displacement of the ion guide. The first and second side guards may comprise first and second guard electrodes or may comprise a series of PCB printed electrodes separated by a resistor chain. The first and second side guards may be physically close the first side and the second side to prevent gas exiting the ion guide 100 via the first side and the second side. In other embodiments, the first side and second side may be open and the first and second side guards may use only electrodes to prevent ions from exiting. In some embodiments, the first and second side guards may be configured to prevent leakages using only physical closures, or using only electrodes, or using a combination of physical closures and electrodes. The embodiment shown in FIG. 3 shows the first and second side guards 170 and 180 as physically closing the first side and the second side.

In some embodiments the ion guide may be configured to increase spatial focussing of the ion beam close to the first exit aperture and the second exit aperture. For example, downstream elements of the mass spectrometer may have a narrow spatial acceptance so it may be beneficial to focus the ion beam exiting the ion guide. The ion guide may be configured to gradually increase spatial focussing of the ion beam as the ion beam approaches the first or second exit aperture.

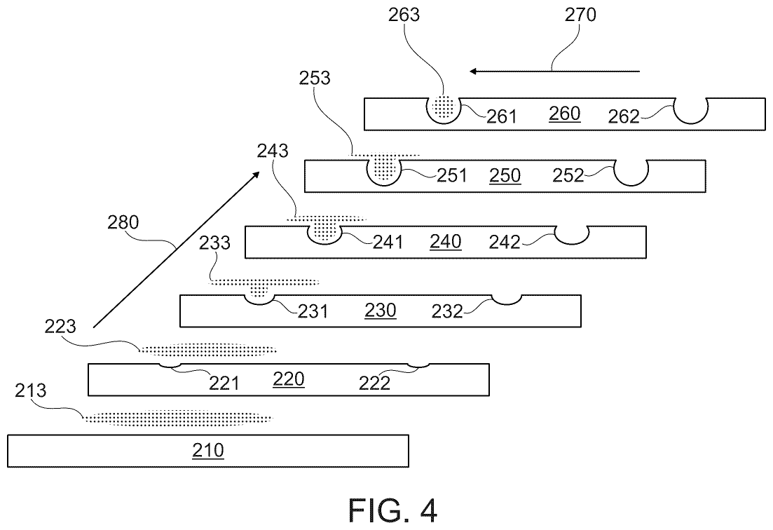

In embodiments where the RF surface comprising RF electrodes comprise elongated electrode plates, the RF electrodes may comprise a channel configured to increase the spatial focussing (i.e. reduce the spatial spread) of the ion beam closer to the first and second exit apertures. With reference to FIG. 4, the RF electrodes may comprise indents that increase in depth nearer to the back wall of the ion guide. For simplicity, only a proportion of the RF electrodes are shown. Of the electrodes shown in FIG. 4, the RF electrode 210 is nearest to the front end of the ion guide and the RF electrode 260 is nearest to the back wall of the ion guide. The front RF electrode 210 comprises an elongated electrode plate with no indent. RF electrodes 220, 230, 240, 250 and 260 each comprise two indents (221, 222, 231, 232, 241, 242, 251, 252, 261, 262) in the top edge of the elongated electrode plate. The indents increase in depth with distance from the front end of the ion guide. The indents may also increase in width with distance from the front end of the ion guide. The indents follow the first ion path and the second path. The DC gradient is configured to guide the ion beam to follow either the first ion path or the second path. In the example shown in FIG. 4, the ion beam follows the left path. The direction of the orthogonal DC that guides the ion beam to the left path is indicated by arrow 270. The direction of the axial DC that accelerates the ion beam towards the back wall is indicated by arrow 280. The ion beam, shown by the dotted areas, passes over the indents of the RF electrodes, and is compressed into the indents by the repelling DC field that confines the ion beam close to the RF surface. The ion beam therefore narrows in focus as it passes over the larger indents and more of the ion beam is accommodated within the indents. The ion beam 213 passing over RF electrode 210 is widest, with a relatively flat cross-section. The ion beam 223 passing over RF electrode 220 is slightly narrower. The ion beam 233 passing over RF electrode 230 is narrower, and a lower portion of the ion beam 233 has started to take on the shape of the indent as the ion beam is compressed into the indent. The ion beam 233 still retains a wider flatter part above the RF electrode. The ion beams 243 and 253 passing over the RF electrodes 240 and 250 have larger lower proportions that are within the indent, and the upper portion that is wider than the indent reduces in size. The ion beam 263 passing over the RF electrode 260 is narrowest and does not have a part that is wider than the indent. There may be more RF electrodes in between those shown in FIG. 4, such that the increase in size of the indents is gradual. The indents are shown as being arcs of circles, but may be other shapes.

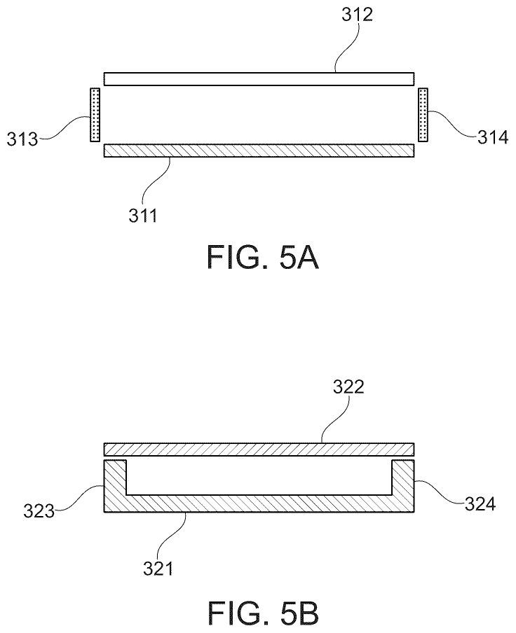

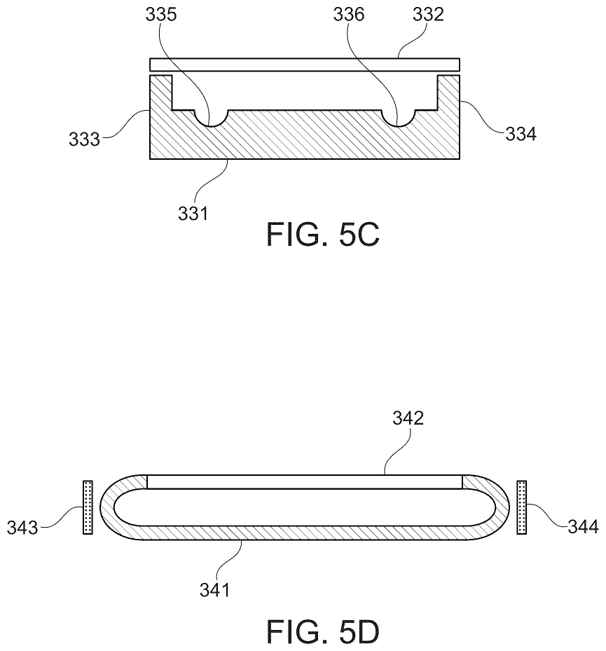

In some embodiments, the RF electrodes may be shaped to provide the first and second side guards, in addition to or instead of being shaped to provide channels. FIG. 5A shows a cross section of an ion guide showing an RF electrode 311 and a DC repeller plate 312. The DC repeller plate 312 may be further configured to apply the DC gradient. The first and second side guards comprise a first DC side guard 313 and a second DC side guard 314. A repulsive DC voltage may be applied to the first and second DC side guards 313 and 314. FIG. 5B shows a cross section of an ion guide showing an RF electrode 321 and a DC repeller plate 322. The RF electrode 321 bends upwards at the ends to form the first side guard 323 and the second side guard 324. The first side guard 323 and the second side guard 324 may be perpendicular to the central portion of the RF electrode 321, at an angle to the central portion of the RF electrode, or the RF electrode may be curved at the ends to form the first and second side guards. FIG. 5C shows a cross-section of a similar configuration to FIG. 5B, where the ends of the RF electrode 331 form the first and second side guards 333 and 334. As in FIG. 5C, the ion guide also comprises a DC repeller plate 332. The RF electrode 331 further comprises a first indent 335 and a second indent 336. The first and second indents 335 and 336 are configured to focus the ion beam as described with reference to FIG. 4. FIG. 5D shows a cross-section of an ion guide comprising a DC repeller plate 342, and an RF electrode 341 that curves at the ends to meet (or approach) the edges of the DC repeller plate 342. The ion guide further comprises attractive DC electrodes 343 and 344. The attractive DC electrodes 343 and 344 may be configured to apply an attractive DC field that pulls the ion cloud towards the edges or corners of the RF electrodes (advantageously, strongly pulling the ion cloud), which improves the focussing of the ion beam,

In certain embodiments, the DC gradient may be applied by applying a DC voltage gradient to the RF electrodes. In other embodiments, the DC gradient may be applied using auxiliary DC electrodes. As will be described in the following, in some embodiments the top plate may comprise auxiliary DC electrodes configured to apply the DC gradient. In other embodiments, the auxiliary DC electrodes may be mounted between the RF electrodes. Both axial and orthogonal components of the DC gradient may be applied using the auxiliary DC electrodes, or both axial and orthogonal components of the DC gradient may be applied using the RF electrodes, or one component may be applied using the auxiliary DC electrodes and the other component may be applied using the RF electrodes.

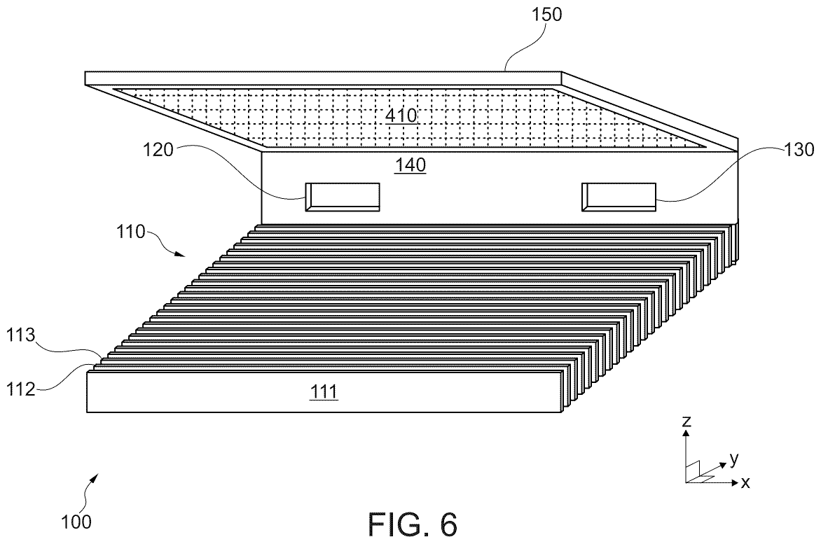

In an embodiment, with reference to FIG. 6, the top plate 150 comprises a repeller plate. In the example shown in FIG. 2, the configuration of the RF surface is the same as in FIG. 3, wherein the RF electrodes comprise elongated electrode plates. As discussed above, the repeller plate may comprise a repulsive DC electrode. The repeller plate may also be configured to apply one or both components of the DC gradient. The repeller plate may comprise a repeller PCB 410 with a printed series of electrodes configured both to act as a repeller and to apply a guiding DC gradient. The DC gradient may be superimposed on the repelling field, such that the ions are guided either to the first exit aperture 120 or to the second exit aperture 130. The DC gradient comprises an orthogonal component, and may also comprise an axial component. The orthogonal DC gradient may be configured to provide a guiding force in both orthogonal directions (left and right). Optionally, the DC gradient may be configured to provide a guiding force in one orthogonal direction only (for example pushing ions either to the left or to the right), whilst the other direction may be provided by a DC series (by linking the series of RF electrodes with resistors and applying DC voltages between the electrodes, so that a series of DC steps between the RF electrodes form a gradient), travelling wave or pulsed DC applied to the RF electrodes. The guiding force of the RF electrodes may depend on the direction in which the RF electrodes are mounted. The RF electrodes may be mounted such that the planes of the elongated electrode plates are parallel to the z-x plane. Optionally, the RF electrodes may instead be mounted such that the planes of the elongated electrode plates are parallel to the z-y plane. The RF electrodes may be configured to provide the orthogonal component of the DC gradient, and the top plate may be configured to provide the axial component of the DC gradient. In another embodiment, the RF electrodes may be arranged in a grid comprising rows of electrodes parallel to the z-y plane and columns of electrodes parallel to the z-x plane, such that DC gradients or travelling waves may be applied in both orthogonal and axial directions.

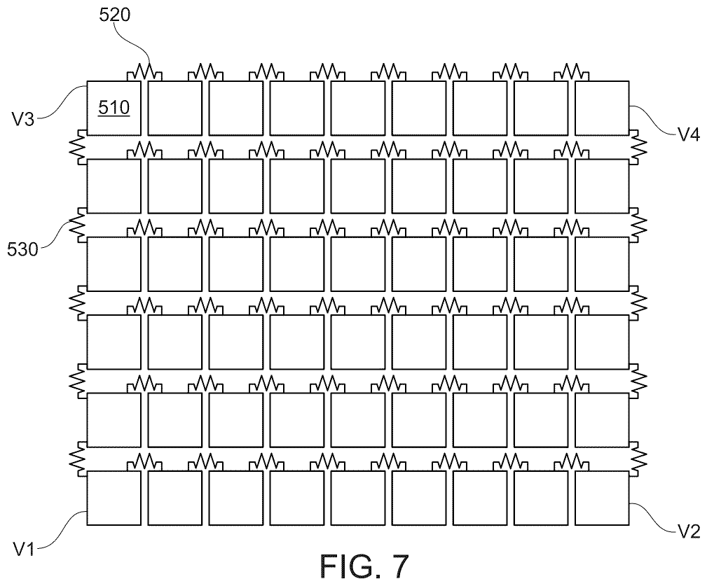

A repeller PCB configured to apply a DC gradient may comprise a series of printed electrodes separated by a resistor chain. A voltage may be applied at each end. A linear DC gradient may be generated by a linear one-dimensional series of electrodes. The ion guide may require a DC gradient in two dimensions, in one dimension to provide the orthogonal DC gradient to guide the ion beam to either the first ion path or the second ion path, and in a second dimension to provide the axial DC gradient to accelerate the ions from the front end of the ion guide to the back wall. With reference to FIG. 7, a diagonal DC gradient may be generated using a grid of printed electrodes separated by resistors. The electrodes are shown by the squares, for example 510. Each electrode in a row is separated by a resistor (for example 520), and the electrodes on the end of each row are separated from the electrodes at the end of the adjacent row by a resistor (for example 530). A two-dimensional DC gradient requires four voltage inputs, one at each corner of the grid (V1, V2, V3 and V4).

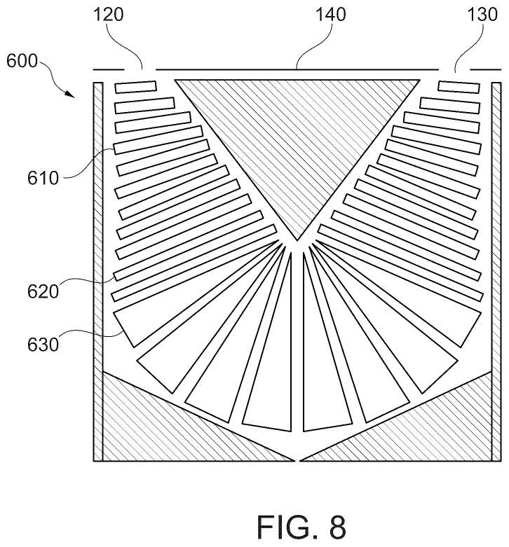

In another embodiment, the top plate 150 may comprise a repeller plate 600 comprising DC electrodes arranged in a shape that defines the first and second ion paths. With reference to FIG. 8, the top plate 150 may comprise a horseshoe-shaped configuration of DC electrodes. The back wall 140 is indicated to show the positions of the first exit aperture 120 and the second exit aperture 130. The bottom of the repeller plate 600 corresponds to the front end of the ion guide. In use, the ion beam enters the ion guide via the front end and the polarity of the DC gradient determines which of the first and second exit apertures 120 and 130 the ion beam is guided to. The DC electrodes may be printed. The DC electrodes are indicated by the white rectangles and triangles (three of the DC electrodes 610, 620 and 630 are labelled in FIG. 8 as examples). The DC electrodes may be segmented differently to form the horseshoe shape. The remaining space around the horseshoe, indicated by hatching, is configured to be repulsive to ions. This may be achieved by the use of DC side guards and/or by other printed electrodes. The width of the channel narrows towards the first and second exit apertures 120 and 130, focussing the ion beam close to the exit apertures and allowing a broad channel near the front end of the ion guide. The repeller plate 600 may be further configured to accept ions that are passed back to the ion guide from downstream elements (for example ion optics) via one of the exit apertures. The ions may be guided to the other exit aperture without altering the DC gradient while the ions are stored within the ion guide.

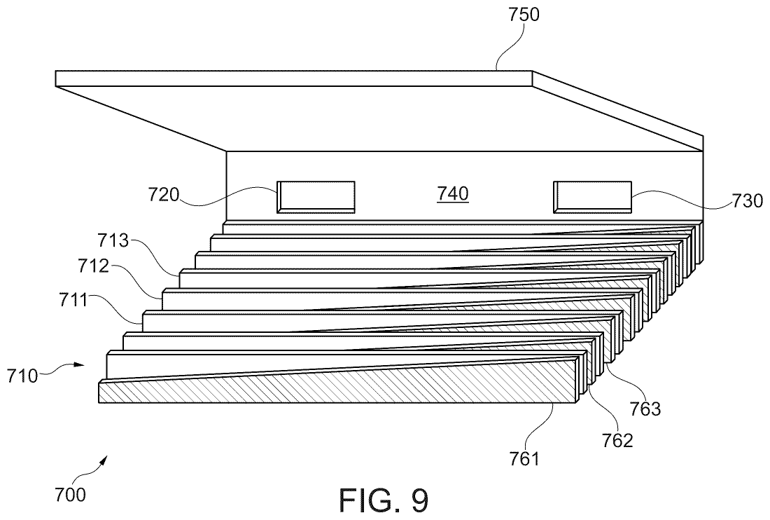

As described above, the top plate 150 may comprise a repeller plate configured to apply the DC gradient in addition the repelling field. With reference to FIG. 9, in an embodiment an ion guide 700 may comprise a top plate 750 that comprises a ground plate or a repeller plate, but does not apply a DC gradient. The ion guide comprises an RF surface 710 similar to that in FIG. 3, wherein RF electrodes comprise elongated electrode plates (three exemplary RF electrodes are labelled as 711, 712 and 713). The ion guide 700 comprises a back wall 740 comprising a first exit aperture 720 and a second exit aperture 730. The ion guide further comprises auxiliary DC electrodes mounted between the RF electrodes, indicated by hatching (three exemplary DC electrodes are labelled as 761, 762 and 763). The static potential felt by the ion beam is a combination of the DC applied to the RF electrodes and the DC applied to the auxiliary DC electrodes. The axial DC gradient may be achieved by varying the height of successive DC electrodes, or by connecting the auxiliary electrodes by a resistor chain. The orthogonal DC gradient may be achieved by having wedge-shaped auxiliary DC electrodes, as shown in FIG. 9.

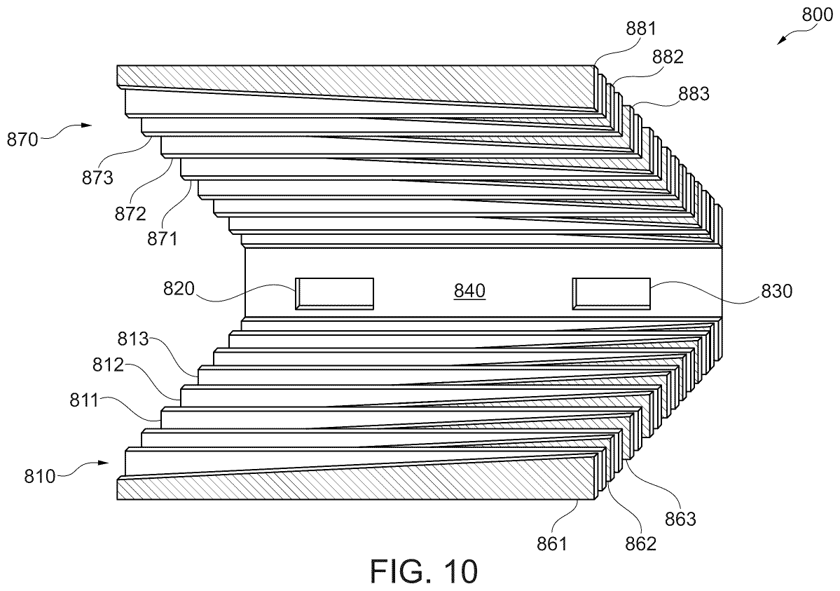

In an embodiment, the top plate 750 shown in FIG. 9 may be replaced by a second RF surface. With reference to FIG. 10, an ion guide 800 comprises a first RF surface 810 that is the same as that shown in FIG. 9. The first RF surface comprises RF electrodes comprising elongated electrode plates (three exemplary RF electrodes are labelled as 811, 812 and 813). The ion guide further comprises auxiliary DC electrodes mounted between the RF electrodes of the first RF surface, indicated by hatching (three exemplary DC electrodes are labelled as 861, 862 and 863). The ion guide 800 comprises a back wall 840 comprising a first exit aperture 820 and a second exit aperture 830. The ion guide 800 comprises a second RF surface 870 at the top of the ion guide. The second RF surface comprises RF electrodes comprising elongated electrode plates (three exemplary RF electrodes are labelled as 871, 872 and 873). The ion guide further comprises auxiliary DC electrodes mounted between the RF electrodes of the second RF surface, indicated by hatching (three exemplary auxiliary DC electrodes are labelled as 881, 882 and 883). The static potential felt by the ion beam is a combination of the DC applied to the RF electrodes of the first and second RF surfaces and the DC applied to the auxiliary DC electrodes mounted between the RF electrodes of the first and second RF surfaces. The axial DC gradient may be achieved by varying the height of successive DC electrodes, or by connecting the auxiliary electrodes by a resistor chain. The orthogonal DC gradient may be achieved by having wedge-shaped auxiliary DC electrodes.

The embodiment shown in FIG. 10 does not comprise a repeller plate, so the ions are not compressed towards either the top or bottom RF surfaces. This arrangement increases the volume available to the ions under space charge. However, as described above it may be beneficial to focus the ion beam near to the exit apertures. In embodiments, this may be achieved by inclining one or both RF surfaces, such that the distance between the first RF surface 810 and the second RF surface 870 decreases closer to the back wall 840. In other embodiments, the DC gradient may be configured to be more strongly attractive for either the auxiliary DC electrodes in the first RF surface or the auxiliary DC electrodes in the second RF surface, pulling the ions towards the surface with the more attractive DC gradient.

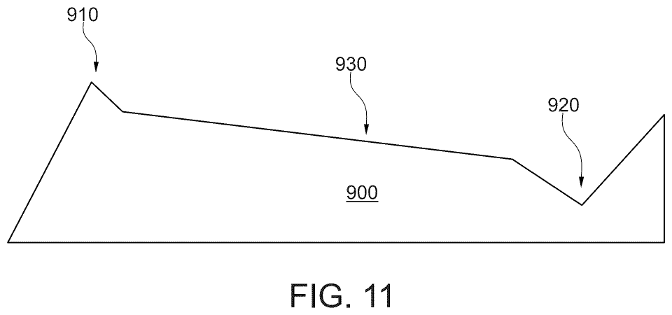

FIGS. 4 and 5C show RF electrodes comprising indents to form a channel in the RF surface. In a similar way, in embodiments where the DC gradient is applied by auxiliary DC electrodes mounted between the RF electrodes, the auxiliary DC electrodes may comprise peaks or troughs to define channels configured to improve spatial focussing of the ion beam close to the exit apertures. This may be in addition to or instead of indents in the RF electrodes. With reference to FIG. 11, an auxiliary DC electrode 900 is shown comprising a peak 910, a trough 920, and a slope 930 between the peak and trough to provide the orthogonal DC gradient. The peak 910 may correspond to the position of the first ion path and the trough 920 may correspond to the position of the second ion path. The ions are guided to either the first or second ion path by choosing the polarity of the DC applied to the auxiliary DC electrode.

It is noted that any of the features described above relating to spatial focussing of the ion beam may be used for spatial focussing of an ion beam travelling from the first ion transport aperture to the second or third ion transport aperture, or for spatial focussing of an ion beam travelling from the second or third ion transport aperture to the first ion transport aperture.

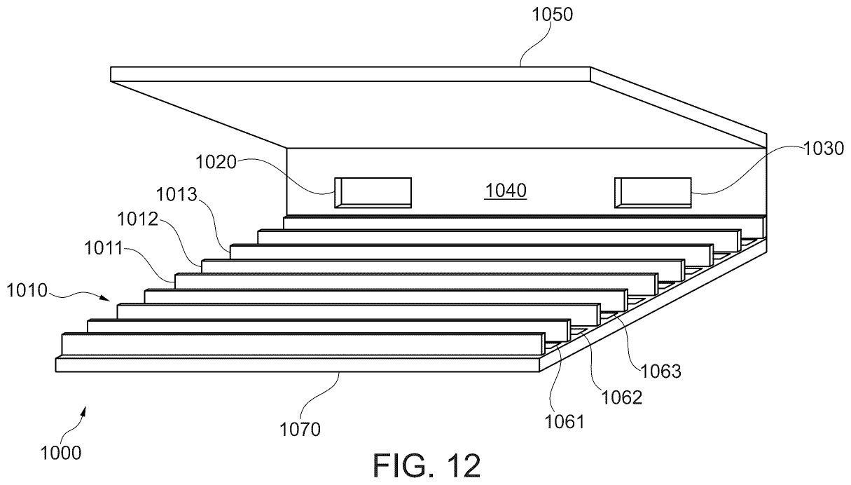

The embodiments described with reference to FIGS. 9 and 10 comprise auxiliary DC electrodes comprising elongated electrode plates. The elongated electrode plates are mounted between the RF electrodes. In other embodiments, the ion guide may comprise auxiliary DC electrodes that are printed between the RF electrodes. With reference to FIG. 12, an ion guide 1000 may comprise an RF surface 1010, a back wall 1040 comprising a first exit aperture 1020 and a second exit aperture 1030, and a top plate 1050. The top plate 1050 may comprise a repeller plate or a ground plate. The ion guide 1000 may further comprise a plurality of auxiliary DC electrodes printed onto a PCB 1070. The RF surface 1010 may comprise RF electrodes mounted between the printed auxiliary DC electrodes. Three RF electrodes 1011, 1012 and 1013 are labelled as examples, and three auxiliary DC electrodes 1061, 1062 and 1063 are labelled as examples. The auxiliary DC electrodes may be separated by resistor chains, for example to form a two-dimensional grid similar to that illustrated in FIG. 7. To reduce contamination, the RF electrodes may overhang the exposed portion of the PCB 1070 between the RF electrodes and the auxiliary DC electrodes (wherein the exposed portion of the PCB 1070 may comprise a dielectric material).

For embodiments comprising auxiliary DC electrodes mounted between the RF electrodes, wherein the auxiliary DC electrodes comprise elongated electrode plates, the heights of the auxiliary DC electrodes relative to the RF electrodes may affect the performance of the ion guide. Preferably, the auxiliary DC electrodes may not protrude above the RF electrodes into the trapping volume of the ion guide. Where auxiliary DC electrodes are recessed below the RF electrodes, the proportion of the applied DC voltage that reaches the centre of the trapping region reduces as the recession of the DC electrodes relative to the RF electrodes increase.

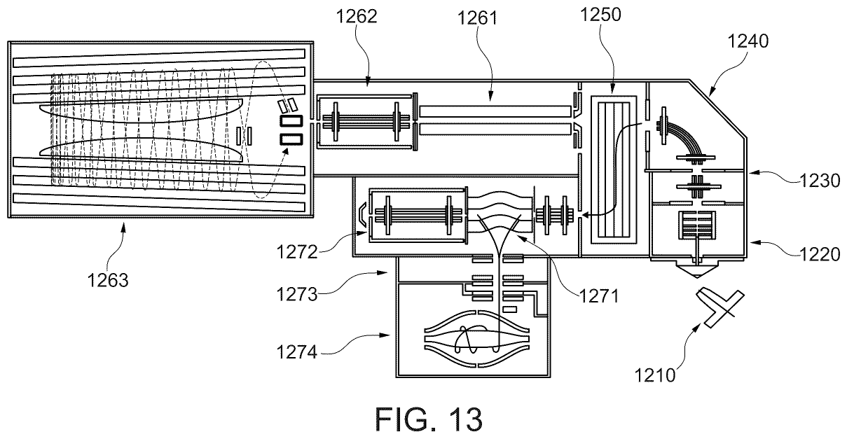

With reference to FIG. 13, an ion guide as described above may be used near the front of a complex hybrid mass spectrometer to separate out fast regions from slow or lossy regions. An example is illustrated in FIG. 13, which shows a schematic of an instrument that combines fast MS2 operation through a fast path to a multi-reflection time-of-flight (MR-ToF) analyser 1263 with a slow path to a Fourier transform mass analyser 1274 for MS1 or with complex ion processing within an adjacent resolving ion trap (wherein MS1 may comprise analysis of unfragmented precursor ions, and MS2 may comprise analysis of fragmented precursor ions). The instrument may comprise an Electrospray ionization (ESI) source 1210, a lens 1220 (such as an S-lens comprising an ion funnel with increasing interpolate spacing between rings), an ion guide 1230 and a 90° ion guide 1240. The ion beam may then pass through a beam-switching ion guide 1250 according to an embodiment of the present disclosure, and the ion beam may be directed to the fast path or to the slow path. The fast path may comprise a quadrupole mass filter 1261, a collision cell 1262 and the MR-ToF analyser 1263. The slow path may comprise a C-trap 1271, a collision cell or resolving ion trap 1272, an ion guide 1273 and the Fourier transform mass analyser 1274. The ion guides 1230, 1240, and 1273 are not beam-switching ion guides in accordance with this disclosure, and guide the ion beam along a single path. Although it would be possible to arrange the analysers in a single path, ion losses through the chain may reduce the sensitivity of the MR-ToF analyser. The chain would be blocked whenever the ion trap performed slower ion manipulations such as MS3 (involving fragmentation of a fragment ion) or Electron-transfer dissociation (ETD). The MR-ToF analyser also blocks the back of the ion trap, preventing possible mounting of a laser for photodissociation fragmentation. For at least these reasons, the ability to switch between the fast and slow paths is beneficial. Furthermore, the fast and slow paths may be arranged side by side to make the instrument more compact than a single long path.

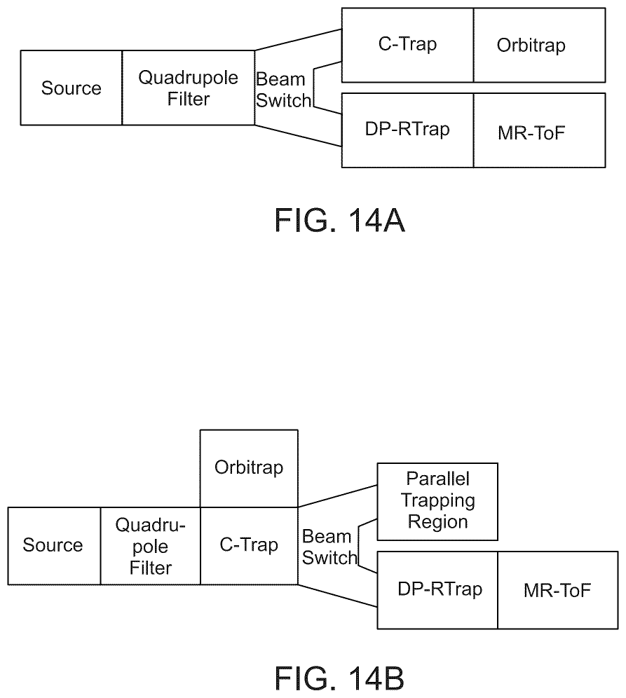

Two possible configurations for an instrument (e.g., a hybrid Fourier transform mass/MR-ToF mass spectrometer) incorporating a branched ion path are illustrated in FIG. 14. These configurations illustrate how a beam switching device may be incorporated into the instrument.

In a first example, the ion beam switch is used to select between paths to a first mass analyser (e.g., a time-of-flight mass analyser) or a second mass analyser (e.g., a Fourier transform mass analyser). Precursor ions from SIM injections are accumulated in a curved linear ion store (e.g., C-Trap), without blocking the ion beam path to the linear ion store (e.g., DP-RTrap).

In a second example, a parallel trapping region for accumulating the precursor ions from the SIM injections is provided. The ion beam switch is used to select between paths to the parallel trapping region and a first mass analyser (e.g., a time-of flight mass analyser). Precursor ions from SIM injections are accumulated in the parallel trapping region, without blocking the ion beam path to the linear ion store (e.g., DP-RTrap). The precursor ions from the combined SIM injections are later passed back through the ion beam switch to a second mass analyser (e.g., a Fourier transform mass analyser).

In a method of operation, the beam switching device flickers between the two routes and, for each mass window in the DIA sequence, makes an injection to the path to the first mass analyser (e.g., time-of flight mass analyser) for MS/MS analysis, and an injection to the path to either the second mass analyser (e.g., a Fourier transform mass analyser) or parallel trapping region, to accumulate ions for an HDR full-MS scan.

In the example illustrated in FIG. 14A, the beam switch is located after the quadrupole mass filter, and operates to send MS2 injections (of fragmented precursor ions) to the time-of-flight mass analyser (optionally via a linear ion store) and SIM injections (of precursor ions) to the first ion store and then to a Fourier transform mass analyser. SIM injections are accumulated together in the first ion store (e.g., C-Trap), in parallel to multiple MS2 injections and scans being made. After a series of SIM injections have been accumulated into the C-Trap then ions may be ejected into the Fourier transform mass analyser for a long acquisition.

In the example illustrated in FIG. 14B, the beam switching device is located after the curved linear ion store (e.g., C-Trap), and so instead switches paths between the linear trap and a new parallel trapping region, such as an ion trap or IRM-like device. Ions accumulated in the parallel trapping region may be passed back to the C-Trap/Fourier transform mass analyser for analysis.

Alternatively, the ions accumulated in the parallel trapping region may be passed to the linear trap/MR-ToF for analysis.

To further improve efficiency, it would be preferable to eliminate the overhead resulting from needing to actively switch beam paths. One way to perform this is to separate out a portion of an ion injection. This may be achieved by discriminating on a property of the ions, such as position or energy. Then, a single (longer) injection could be separated and used to supply two ion destinations. Even more preferably, the conditions are set so that a proportion of the ion beam is separated, either as a function of collisional cooling or spatial distribution, and the split ion beam is delivered to separate ion destinations. This then saves further on time overhead between injections. A method of beam splitting via skimming off a section of a broad ion packet is therefore provided. The ion beam is split by passing the ions over a wedged electrode. The ions are separated based on a spatial distribution of the ion packet.

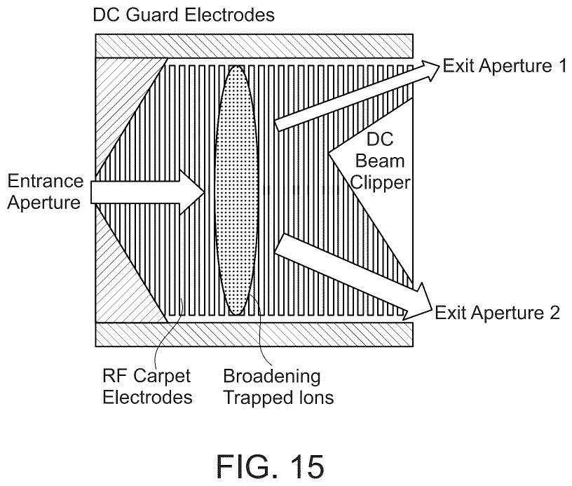

FIG. 15 illustrates an ion beam splitter. In this specific example, the ion beam splitter comprises a pair of RF surfaces or a single RF carpet, with side guards and a wedged DC electrode (also called a beam splitting electrode or “Beam Clipper”) positioned between the entrance and exit apertures. Ions are injected through an entrance aperture and the distribution allowed to broaden across the width of the guide. Ions may be trapped during this period, for example by the direction of an applied DC gradient across the RF electrodes. After the ions have diffused across the width, a DC gradient or travelling wave pulls the ions towards the exit apertures. The ions are repelled by the wedge electrode electric field, but are still drawn over, causing the wedge to cut the ion distribution in two, and the resulting distinct ion populations are drawn to their nearest exit aperture.

The proposed ion splitter builds on principles of beam switching devices previously proposed (such as described in UK Patent Application Number 2209555.8,or patent publications U.S. Pat. No. 7,829,850B2, US2019/0103261A1, U.S. Pat. No. 8,581,181B2 or U.S. Pat. No. 9,984,861B2), to create a branched ion path. Instead of switching the ion beam between destinations, the proposed beam splitter provides proportional separation of the ion beam over a wedge electrode. The device of FIG. 15 could be used to replace the ion routing multipole/fragmentation chamber 12 within the hybrid mass spectrometer of FIG. 1.

Once the ion beam splitter has been used to separate out a portion of the precursor ions, the split off ions have to be stored somewhere. Therefore, a further change to the configuration of the instrument of FIG. 1 is required to incorporate an additional ion store.

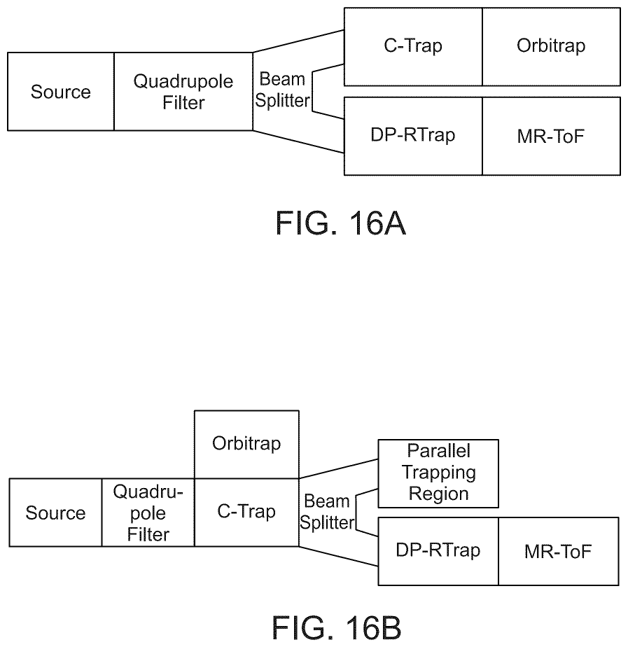

Two possible configurations for an instrument (e.g., a hybrid Fourier transform/MR-ToF mass spectrometer) incorporating a branched ion path are illustrated in FIG. 16. These configurations illustrate how a beam splitting device may be incorporated into the instrument of FIG. 1. Both configurations provide the ability for parallel ion trapping at the first ion destination in either a C-Trap (FIG. 16A) or an additional trapping region (FIG. 16B), without blocking the ion beam path to second ion destination (e.g., the linear trap or time-of-flight mass analyser).

In the first configuration, illustrated in FIG. 16A, the ion beam splitter is located after the quadrupole mass filter, and operates to send MS2 injections to the first mass analyser (e.g., a time-of-flight mass analyser) via a first ion store (e.g., a linear ion store), and SIM injections to a second mass analyser (e.g., a Fourier transform mass analyser) via a second ion store (e.g., a curved linear ion store). SIM injections would be accumulated together in the first ion store, in parallel to multiple MS2 injections and scans being made. After a series of SIM injections have been accumulated in the first ion store then ions may be ejected into the second mass analyser (e.g., for a long acquisition). Advantageously, because precursor ions from the SIM injections are accumulated in a curved linear ion store (e.g., C-Trap), they do not block the ion beam path to the linear ion store (e.g., DP-RTrap).

In the second configuration the ion beam splitter device is located after the curved linear ion store (e.g., C-Trap), and so instead splits the ions between the second ion store (e.g., linear trap) and an intermediate ion store (also called a “parallel trapping region”). The intermediate ion store may be an ion trap or IRM-like device. Alternatively, the intermediate ion store may be provided by a DC barrier, replacing the first exit aperture of the ion beam splitter, so that ions are accumulated at the first outlet region (e.g., at the end of the wedge of the ion beam splitter).

Once the SIM ions from the plurality of sub-ranges have been accumulated in the parallel trapping region, the precursor ions may be passed back through the ion beam splitter to a third ion store (e.g., a C-Trap) and ejected from the third ion store to a second mass analyser (e.g., Fourier transform mass analyser).

Alternatively, once the SIM ions from the plurality of sub-ranges have been accumulated in the parallel trapping region, the precursor ions may be passed through the ion beam splitter to the second ion destination (e.g., linear trap/MR-ToF).

To minimise overhead it is advantageous that the beam splitting device and/or beam switching device be relatively fast, with voltage transitions and sufficient ion transport to eliminate mixing preferably taking approximately 1 millisecond or less. If the process were relatively slow, ions could be first accumulated prior to the switching region, such as in the C-Trap, to allow parallelisation of accumulation with the later ion transport.

In a DIA method, most of the ions will be sent for analysis as a series of MS2 scans, whilst a proportion will be split off and may be accumulated. This build-up of ions may be analysed using a Fourier transform mass analyser to provide a HDR scan, in a similar manner to the “Boxcar” method described in the background.

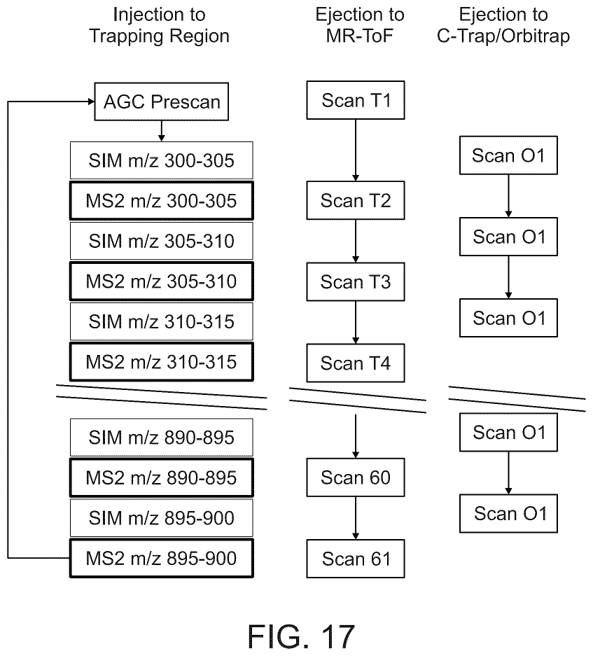

FIG. 17 shows a graphical explanation of a DIA method that may be implemented on the mass spectrometers of FIGS. 1, 13, 14 and 16. In a DIA method according to some specific examples, for every injection that is performed with fragmentation, there is an additional injection with the same quadrupole isolation window and reduced or no collision energy. The target mass is scanned through a predetermined range and isolation step size as is normal for DIA. FIG. 17 shows such a scan sequence from m/z 300-900 Th, with 5 Th isolation windows, as may be used for “bottom-up” measurement of digested protein samples. An optional AGC (automatic gain control) pre-scan may be performed (preferably in the time-of-flight mass analyser) to help determine suitable ion injection times in subsequent scans. Alternatively, an optional MS1 full scan may be performed using the Fourier transform mass analyser (e.g., Orbitrap™ mass analyser). The MS2 injections are passed to the linear trap and extracted to the time-of-flight (e.g., MR-ToF) mass analyser for a series of scans (T1 to T61). The SIM injections are accumulated together in an ion store, such as a curved linear ion store (C-Trap) or other ion trapping device. An HDR MS1 scan can be generated by analysing the combined precursor ions (e.g., in the Fourier transform mass analyser).

The SIM and MS2 injections are interleaved to minimise the quadrupole and source switching time overhead, which might otherwise greatly reduce the time available for ion accumulation. At the end of the cycle, the accumulated series of SIM injections are then extracted to the Fourier transform mass analyser for a long transient analysis, for example at 240K resolution.

It is advantageous that AGC is used to control the number of ions in the curved linear ion store and Fourier transform mass analyser, so that the total number of ions in each SIM injection does not add up to a level that overwhelms the ion store. For example, if there are 60 SIM injections per cycle, then one might limit the number of ions in each SIM injection to ˜1500 ions.

For longer cycles, an additional scan using the Fourier transform mass analyser may be performed in the middle of the cycle, to increase the dynamic range of the precursor scan data, at the cost of reducing maximum transient time by half. In other words, SIM injections from the first half of the plurality of sub-ranges may be analysed together in a first scan and SIM injections from the second half of the plurality of sub-ranges may be analysed together in a second scan.

More generally, rather than performing one scan for precursor ions from the overall m/z range, the method may comprise a plurality of scans of precursor ions, where each scan comprises precursor ions from a plurality of sub-ranges.

The method of FIG. 17 may be performed on the combined Fourier transform mass analyser and MR-ToF instrument illustrated in FIG. 1, as modified in accordance with FIG. 14. Alternatively, the method may be performed on a single mass analyser instrument, such as a ToF-only instrument or a Fourier transform mass analyser-only instrument (and may take longer).

The timings of the different operations may be configured so that certain operations are performed in parallel, to reduce the overall time taken. The Fourier transform/MR-ToF instrument illustrated in FIG. 1 is capable of running single injections at approximately 200 Hz with a 3 ms inject time (also referred to as “fill time”) and 2 ms overhead. Additional overhead would deplete the duty cycle and reduce instrument sensitivity.

The ions are transported from the ion source through to the analyser. Multiple separate ion packets may be processed simultaneously in the different components.

SIM/MS2 injections may be interleaved, dependent on whether fragmentation is carried out in the IRM 120 or the high-pressure region of the extraction trap 140. Injections (also referred to as “fills”) may be made and directed by the branched ion path into the ion store (also referred to as the “extraction trap”) or mass analyser, in such a way as to minimise additional overhead. The additional injections may relate to precursor ions from the ion filter having the same m/z characteristics. During operation according to some example methods, the collision energy of the fragmentation chamber may be adjusted. The fragmentation energy may be adjusted from a pre-set MS2 level, which is used to produce the sample of fragmented precursor ions, to a reduced level such as zero so that the precursor ions pass through the fragmentation chamber unfragmented.

The ions from differing injections should not be mixed before the fragmentation step. If fragmentation is performed upstream of the ion beam switch (e.g., in an IRM collision cell) then the second injection follows the first after a short delay required to change the IRM offset. Since the ions transported in the ion beam switch are of different types (precursor ions transported to the first ion destination and fragment ions transported to the second ion destination), the ion beam switch should be cleared of the first ion packet before admitting the second ion packet.

If fragmentation is performed downstream of the ion beam switch (e.g., by the high-pressure region of the extraction trap), the ion beam switch should be cleared of the first ion packet before admitting the second ion packet. Nevertheless, because the second injection has the same m/z range as the first injection (the ion beam switch is transporting precursor ions to both ion destinations), the need to thoroughly clear regions of ions between injections is lessened.

In a further variation of the DIA process illustrated in FIG. 17, stepped fragmentation energies may be applied for each MS2 scan. In other words, the MS2 ions are added to the second ion store in multiple injections, each injection having a different fragmentation energy.

In some variations of the methods, where a pre-scan is performed, it may be preferable not to perform SIM injections for m/z sub-ranges of the overall precursor mass range that are already heavily populated. This may be determined from the full-MS pre-scan, which should be able to gather sufficient data for such regions. Omitting SIM injections for these sub-ranges may further reduce the time required for the overall method and improve the resolution of the scan(s) for the combined SIM injections. A HDR MS1 scan can be obtained by combining the full-MS pre-scan with the scan for the combined SIM injections.

Herein the term mass may be used to refer to the mass-to-charge ratio, m/z. The resolution of a mass analyser is to be understood to refer to the resolution of the mass analyser as determined at a mass to charge ratio of 200 unless otherwise stated.

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that, for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise.

Unless otherwise defined, all other technical and scientific terms used herein have the meaning commonly understood by one of ordinary skill in the art to which this invention belongs. In case of conflict, the present specification, including definitions, will control. It will be appreciated that there is an implied “about” prior to the quantitative terms mentioned in the present description, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting and do not exclude the possibility that other elements are also included. Where the word “consisting” is used, this is intended to indicate that other elements are excluded. As used herein, “a” or “an” also may refer to “at least one” or “one or more.” Also, the use of “or” is inclusive, such that the phrase “A or B” is true when “A” is true, “B” is true, or both “A” and “B” are true.

As used in this document, the term “scan”, when used as a noun, means a mass spectrum, regardless of the type of mass analyzer used to generate and acquire the mass spectrum. When used as a verb herein, the term “scan” refers to the generation and acquisition of a mass spectrum by a method of mass analysis, regardless of the type of mass analyzer or mass analysis used to generate and acquire the mass spectrum. As used herein, the term “full scan” refers to a mass spectrum than encompasses a range of mass-to-charge (m/z) values that includes a plurality of mass spectral peaks.

As used in this document, each of the terms “liquid chromatograph” and “liquid chromatography” (both abbreviated “LC”) as well as the term “Liquid Chromatography Mass Spectrometry” (abbreviated as “LC-MS”) are intended to apply to any type of liquid separation system that is capable of separating a multi-analyte-bearing liquid sample into various “fractions” or “separates”, where the chemical composition of each such “fraction” or “separate” is different from the chemical composition of every other such fraction or separate, wherein the term “chemical composition” refers to the numbers, concentrations, and/or identities of the various analytes in a fraction or separate. As such, the terms “liquid chromatograph”, “liquid chromatography” “Liquid Chromatography Mass Spectrometry”, “LC”, and “LC-MS” are intended to include and to refer to, without limitation, liquid chromatographs, high-performance liquid chromatographs, ultra-high-performance liquid chromatographs, size-exclusion chromatographs and capillary electrophoresis devices.

Instead of the LC device any other separation device, including an ion mobility device, HPLC, GC or ion chromatography could be interfaced to the mass spectrometer. Also any known fragmentation method (including collisionally activated dissociation, photon induced dissociation, electron capture or electron transfer dissociation) produces data suitable for use with the invention.

Although embodiments according to the disclosure have been described with reference to particular types of devices and applications (particularly mass spectrometers) and the embodiments have particular advantages in such case, as discussed herein, approaches according to the disclosure may be applied to other types of device and/or application. The specific manufacturing details of the ion guide and associated uses, whilst potentially advantageous (especially in view of known manufacturing constraints and capabilities), may be varied significantly to arrive at devices with similar or identical operation. Each feature disclosed in this specification, unless stated otherwise, may be replaced by alternative features serving the same, equivalent or similar purpose. Thus, unless stated otherwise, each feature disclosed is one example only of a generic series of equivalent or similar features.

The use of any and all examples, or exemplary language (“for instance”, “such as”, “for example” and like language) provided herein, is intended merely to better illustrate the invention and does not indicate a limitation on the scope of the invention unless otherwise claimed. No language in the specification should be construed as indicating any non-claimed element as essential to the practice of the invention.

Any steps described in this specification may be performed in any order or simultaneously unless stated or the context requires otherwise.

All of the aspects and/or features disclosed in this specification may be combined in any combination, except combinations where at least some of such features and/or steps are mutually exclusive. As described herein, there may be particular combinations of aspects that are of further benefit, such the aspects of ion guides for use in mass spectrometers and/or ion mobility spectrometers. In particular, the preferred features of the invention are applicable to all aspects of the invention and may be used in any combination. Likewise, features described in non-essential combinations may be used separately (not in combination).

We claim:

1. A method of mass spectrometry comprising the steps of:
for each of a plurality of sub-ranges selected from an overall m/z range:
configuring an ion beam switch to direct ions towards a first ion store;
accumulating in the first ion store a sample of precursor ions to be analysed, the precursor ions having m/z values within the sub-range; and either:
a) configuring the ion beam switch to direct ions towards a first mass analyser and injecting a sample of fragmented precursor ions into the first mass analyser, or
b) configuring the ion beam switch to direct ions towards a second ion store and accumulating in the second ion store a sample of fragmented precursor ions for analysis in a first mass analyser,
wherein the sample of fragmented precursor ions are formed from fragmentation of precursor ions having m/z values within the sub-range.

2. The method of claim 1, wherein the samples of precursor ions for each of the plurality of sub-ranges are combined together in the first ion store, so that the first ion store contains precursor ions having m/z values from the overall m/z range.

3. The method of claim 1, wherein the first ion store is an intermediate ion store, wherein the method further comprises configuring the ion beam switch to transfer precursor ions accumulated in the first ion store to a third ion store for analysis in a second mass analyser.

4. The method of claim 3, wherein the precursor ions transferred from the first ion store to the third ion store comprise the samples of precursor ions for each of the plurality of sub-ranges.

5. The method of claim 3, wherein precursor ions are transferred from the first ion store to the third ion store after the samples of fragmented precursor ions for each of the plurality of sub-ranges have been accumulated in the second ion store.

6. The method of claim 1, wherein the first ion store is an intermediate ion store, wherein the method further comprises configuring the ion beam switch to transfer precursor ions accumulated in the first ion store to a) the first mass analyser or b) the second ion store.

7. The method of claim 6, wherein the precursor ions transferred from the first ion store comprise the samples of precursor ions for each of the plurality of sub-ranges.

8. The method of claim 6, wherein the ion beam switch is configured to direct ions towards the second ion store and the sample of fragmented precursor ions is accumulated in the second ion store, further comprising ejecting the sample of fragmented precursor ions accumulated in the second ion store into the first mass analyser, wherein the precursor ions are transferred from the first ion store to the second ion store after the samples of fragmented precursor ions for each of the plurality of sub-ranges have been ejected from the second ion store into the first mass analyser.

9. The method of claim 1, wherein the ion beam switch is configured to operate under pure molecular flow conditions.

10. The method of claim 1, wherein the method further comprises fragmenting the precursor ions to produce the sample of fragmented precursor ions, wherein either:
the ion beam switch is configured to direct ions towards the second ion store and the sample of fragmented precursor ions is accumulated in the second ion store, wherein the ions are fragmented in the second ion store; or
the ions are fragmented using a multipole collision cell.

11. The method of claim 1, further comprising, for each of the plurality of sub-ranges:
configuring an ion filter to transmit precursor ions having m/z values within the sub-range, wherein the sample of precursor ions is received from the configured ion filter, and the sample of fragmented precursor ions is formed from fragmentation of precursor ions received from the configured ion filter.

12. The method of claim 11, wherein configuring the ion filter comprises setting a transmission window of the ion filter, wherein the transmission window is adjusted between each of the plurality of sub-ranges, wherein for each sub-range, the transmission window for the step of accumulating the sample of precursor ions is the same as the transmission window for the step of injecting the sample of fragmented precursor ions into the first mass analyser or accumulating the sample of fragmented precursor ions in the second ion store.

13. The method of claim 11, further comprising configuring an ion mobility separator to transfer precursor ions having m/z values within the sub-range to the ion filter.

14. The method of claim 13, further comprising controlling the ion mobility separator so that the precursor ions transferred to the ion filter correspond with a transmission window of the ion filter, for each of the plurality of sub-ranges in the overall m/z range.

15. The method of claim 1, wherein accumulating the sample of precursor ions comprises controlling a fill time for the precursor ions, based on a relative abundance of precursor ion species in the corresponding sub-range.

16. The method of claim 1, wherein the ion beam switch is configured to direct ions towards the second ion store and the sample of fragmented precursor ions is accumulated in the second ion store, the method further comprising, for each of the plurality of sub-ranges, ejecting the sample of fragmented precursor ions into the first mass analyser and analysing the sample of fragmented precursor ions in the first mass analyser, wherein the plurality of sub-ranges comprises a first sub-range and a second sub-range, wherein the step of analysing the sample of fragmented precursor ions from the first sub-range at least partially overlaps with the step of accumulating, in the second ion store, the sample of fragmented precursor ions formed from fragmentation of precursor ions having m/z values within the second sub-range.

17. The method of claim 16, wherein the plurality of sub-ranges comprises a first sub-range and a second sub-range, wherein the step of analysing the sample of fragmented precursor ions from the first sub-range at least partially overlaps with the step of accumulating the sample of precursor ions having m/z values within the second sub-range in the first ion store.

18. The method of claim 1, wherein the first mass analyser is a time-of-flight, ToF, analyser.

19. The method of claim 1, wherein the first ion store is a curved linear ion trap.

20. The method of claim 1, wherein the ion beam switch is configured to direct ions towards the second ion store and the sample of fragmented precursor ions is accumulated in the second ion store, wherein the second ion store is a linear ion trap.

21. The method of claim 1, further comprising:
configuring an ion filter to transmit precursor ions having m/z values from the overall m/z range;
transferring an initial sample of precursor ions having m/z values from the overall m/z range to the first mass analyser or a second mass analyser;
analysing the initial sample of precursor ions; and
obtaining scan data for the overall m/z range from analysis of the initial sample of precursor ions.

22. The method of claim 21, further comprising selecting the plurality of sub-ranges from the overall m/z range, based on the scan data obtained from analysis of the initial sample of precursor ions.

23. A method of mass spectrometry comprising the steps of:
for each of a plurality of sub-ranges selected from an overall m/z range:
configuring an ion beam splitter to direct ions towards a first ion destination and a second ion destination, wherein the first ion destination is a first ion store; and
accumulating in the first ion store a sample of precursor ions to be analysed, the precursor ions having m/z values within the sub-range, wherein either:
a) the second ion destination is a first mass analyser, and wherein the method further comprises injecting a sample of fragmented precursor ions into the first mass analyser, or
b) the second ion destination is a second ion store, and wherein the method further comprises accumulating in the second ion store a sample of fragmented precursor ions for analysis in a first mass analyser,
wherein the sample of fragmented precursor ions are formed from fragmentation of precursor ions having m/z values within the sub-range.

24. A mass spectrometer configured to perform the method of claim 23.

25. At least one computer readable medium having stored thereon instructions that, when executed by a processor of a computer, cause the computer to perform the method of claim 1.
